(19) United States
(12) Patent Application Publication
(10) Pub. No.: US 2010/0058333 A1
(43) Pub. Date: Mar. 4, 2010

(54) Method, system and computer-readable medium for personalized gadget configuration

(76) Inventor: Harold Lee Peterson, Scotts Valley, CA (US)

Correspondence Address: PATRICK REILLY, P.O. BOX 7218, SANTA CRUZ, CA, 95061-7218, US

(21) Appl. No.: 12/456,138

(22) Filed: Jun. 10, 2009

Related U.S. Application Data
(60) Provisional application No. 61/131,759, filed on Jun. 11, 2008.

(51) Int. Cl. G06F 3/01; G06F 9/445; G06F 15/16; G06Q 20/00; G06Q 50/00; G06Q 10/00

(52) U.S. Cl. 717/178; 715/745; 709/206; 705/40; 705/317

(57) ABSTRACT

A system and method for selecting gadgets for enablement during or related to a consumer's out-of-the-box experience with a newly purchased computational device are provided. Information and selections provided or input by the user direct the computer to select or identify one or more gadgets for presentation to the user. Two or more profiles each include at least one gadget; the information and selections received from the user are compared to aspects of the profiles to determine user-profile matches. Each match with a profile causes the device to make the user aware of and/or enable user accessibility to one or more gadgets associated with each matching profile. The user may self select one or more profiles and/or may provide data that upon directs the device to select one or profile, wherein gadgets associated with each selected profile may be made accessible and/or at least partially downloaded from the Internet.

### CROSS-REFERENCE TO CO-PENDING PATENT APPLICATIONS

This United States Nonprovisional patent application is a Continuation-in-Part application for patent of Provisional Patent Application No. 61/131,759, filed Jun. 11, 2008, titled “Method, system and computer-readable medium for personalized gadget configuration”, by inventor Harold Lee Peterson, hereby incorporated by reference in its entirety and for all purposes.

### FIELD OF THE INVENTION

The present invention relates to the computational services and software. The present invention more particularly relates to enabling access to computational services provided through, and software enabling interaction with, one or more electronic communications networks.

### BACKGROUND OF THE INVENTION

Certain prior art electronic devices that enable bi-directional communications with one or more electronic communications networks, such as the Internet, computer networks and telephony networks, are capable of employing software gadgets as directed at least partially by a user A software gadget may provide a valuable informational or communications service to an individual user, yet the multiplicity of available software gadgets can bewilder or overwhelm a consumer of information technology services.

In particular, a purchaser of an electronics device may be directed, or even forced, by the operation of the device in an out-of-box-experience to examine one or more gadgets as part of an initial consumer experience as designed by the manufacturer or marketer of the device. While many software gadgets can provide a desirable service or experience to certain consumers, the process of evaluating and selecting, or de-selecting, a plurality of gadgets can discomfort many consumers.

Yet the inclusion of software gadgets in an electronic device can result in the receipt by the manufacturer or marketer of certain consumer electronic devices with a significant and perhaps commercially irreplaceable source of revenue. This revenue stream, made available to certain manufacturers and marketers of personal computers, cellular telephones, personal digital assistants, and other communications enabled electronic devices, allows applicable manufacturers and marketers to offer products at lower prices to the consumer while maintaining a sustaining level of profit.

The prior art fails to optimally provide a method to conveniently offer the use of a variety of gadgets to a user, consumer or purchaser of an electronic device as selected from a larger plurality of gadgets that may be made available for use.

The terms “software gadget” and “gadget” are defined herein to include a software application that can sit on a user's computer desktop, or are hosted on a web page of the World Wide Web (hereafter, “web”). Certain web gadgets may run on a web site, such as Live.com or Spaces.Live.com. A sidebar gadget may run on the visually displayed desktop image of a computer (hereafter, “desktop”) or be docked onto, run within a sidebar visual representation, e.g., a sidebar as generated by a Windows™ personal computer operating system as marketed by Microsoft Corporation of Redmond, Wash. A sideshow gadget may run on an auxiliary external display, such as on a visual display located on an exterior side of a personal computer, or a liquid crystal display panel of a keyboard, and potentially mobile phones and other devices.

Various gadgets may enable a user to direct a hosting computer to perform information searches of (1.) a user's e-mails, (2.) computer files, (3.) digitized music files, (4.) digitized photographic documents, (5.) digitized chat archives, and/or (6.) a history of web pages previously viewed by means of the hosting computer. An email gadget may allow a computer to display an icon that enables a user to direct the hosting computer to visually display email messages. A scratch pad may allow a computer to display an icon that enables a user to direct the hosting computer to accept, store and display random digitized notes. A photographic gadget may allow a computer to display an icon that enables a user to direct the hosting computer to display a slideshow of visual images generated from a folder containing a plurality of photographic digitized documents. A news gadget may allow a computer to display headlines and other information received from a web service news and information provider. A weather gadget may allow a computer to display an icon that enables a user to direct the hosting computer to display weather information related to a location specified by the user as received from a web service. A web clip gadget may allow a computer to direct a hosting computer to visually display information received form web based news feeds, e.g., really simple syndication enabled information services.

Prior art methods enable a user to select gadgets from a plurality of preinstalled, or pre-associated gadget software. Yet the prior art fails to optimally offer information concerning, or to optimally enable a convenient selection of software gadgets to a consumer during the lifetime of an electronic communication device and/or optionally or additionally to select one or more gadgets for use during and after a user experience occurring after proximate to purchase of selected electronic devices. The user experience generated by the interaction of a user with an electronic device during the purchase, evaluation and/or first boot-up process of an electronic communications device is referred to as “out of box experience” in the art. There is therefore a long felt need to improve the effectiveness of selecting gadgets for enablement and/or access during a consumer's use of certain electronic devices during the lifetime of the device, to optionally, additionally or alternatively include the out-of-the-box experience with a newly purchased computational device.

### SUMMARY OF THE INVENTION

Towards this object and other objects that will be made obvious in light of this disclosure, a first version of the method of the present invention provides a method and system enabling selection of one or more gadgets during, or related to, a consumer's out-of-the-box experience with a newly purchased computational device.

The foregoing and other objects, features and advantages will be apparent from the following description of aspects of the method of the invention as illustrated in the accompanying drawings.

### INCORPORATION BY REFERENCE

All publications mentioned herein are incorporated herein by reference to disclose and describe the methods and/or materials in connection with which the publications are cited. All publications, patents, and patent applications mentioned in this specification are herein incorporated by reference in their entirety and for all purposes to the same extent as if each individual publication, patent, or patent application was specifically and individually indicated to be incorporated by reference.

U.S. Pat. No. 7,222,106 (Block, et al., issued May 22, 2007); U.S. Pat. No. 6,823,508 (Burckhardt, et al., issued Nov. 23, 2004); U.S. Pat. No. 7,062,645 (Crooning, issued Jun. 13, 2006); U.S. Pat. No. 6,345,294 (O'Toole, et al., issued Feb. 5, 2002); U.S. Pat. No. 6,757,723 (O'Toole, et al., issued Jun. 29, 2004); United States Patent Publication No. 20080120596 (Kothari et al., published May 22, 2008); United States Patent Publication No. 20080097843 (Menon, et al., published Apr. 24, 2008); and United States Patent Publication No. 20070198946 (Viji, et al., published Aug. 23, 2007) are incorporated herein by reference in their entirety and for all purposes.

United States Patent Publication No. 20080120596 (inventors: Kothari et al.; published on May 22, 2008); United States Patent Publication No. 20080097843 (Menon, et al.; published on Apr. 24, 2008); and United States Patent Publication No. 20070198946 (Viji, et al., published Aug. 23, 2007); United States Patent Application Publication No. 20090113444 (inventors: Hackborn; Dianne K., et al.; published on Apr. 30, 2009) titled “Application Management”; United States Patent Application Publication No. 20080271078 (inventors: Gossweiler; Richard C., et al.; published on Oct. 30, 2008) titled “Momentary Electronic Program Guide”; United States Patent Application Publication No. 20070139430 (inventors: Korn; David S., et al.; published on Jun. 21, 2007) titled “Rendering “gadgets” with a browser”; United States Patent Application Publication No. 20090100154 (inventors: Stevenson; Daniel C., et al.; published on Apr. 16, 2009) titled “AUTOMATICALLY INSTRUMENTING A SET OF WEB DOCUMENTS”; United States Patent Application Publication No. 20070198946 (inventors: Viji; Sriram, et al.; published on Aug. 23, 2007) titled “Auxiliary display sidebar integration”; United States Patent Application Publication Ser. No. 20080077873 (Peterson, Harold Lee; Mar. 27, 2008) entitled “Apparatus, method and computer-readable medium for organizing the display of visual icons associated with information technology processes”; and U.S. patent application Ser. No. 09/423,025 (Peterson, et al.; filed on Oct. 28, 1999) entitled “Digital content vending, delivery and maintenance system” are incorporated herein by reference in this patent application in their entirety and for all purposes.

The publications discussed or mentioned herein are provided solely for their disclosure prior to the filing date of the present application. Nothing herein is to be construed as an admission that the present invention is not entitled to antedate such publication by virtue of prior invention. Furthermore, the dates of publication provided herein may differ from the actual publication dates which may need to be independently confirmed.

### BRIEF DESCRIPTION OF THE DRAWINGS

These, and further features of the invention, may be better understood with reference to the accompanying specification and drawings depicting the preferred embodiments, and aspects thereof, of the present invention in which:

FIG. 1 is a process chart of a business method in accordance with certain aspects of the method of the present invention;

FIG. 2 is a block diagram illustrating an exemplary computer in accordance with the method of the present invention;

FIG. 3 is a software flowchart of a process whereby the computer of FIGS. 2, 7 and 8 may implement certain alternate, optional or additional aspects of the method of the present invention;

FIG. 4 is a software flowchart of a process whereby the computer of FIG. 2 may implement certain alternate, optional or additional aspects of the method of the present invention;

FIG. 5 is a software flowchart of a process whereby the computer of FIGS. 2, 7 and 8 may implement yet other alternate, optional or additional aspects of the method of the present invention;

Referring now generally to the Figures and particularly to FIGS. 6A and 6B, FIGS. 6A and 6B are software flowcharts of a process whereby the computer of FIGS. 2, 7 and 8 and the electronic communications network of FIG. 8 may implement certain even other certain alternate, optional or additional aspects of the method of the present invention;

FIG. 7 is a block diagram of the computer of FIG. 2 with illustrations of additional aspects of the computer;

FIG. 8 is a block diagram of an electronics communications network by which additional certain alternate, optional or additional aspects of the method of the present invention may be implemented;

FIG. 9 is a software flowchart of still other certain alternate, optional or additional aspects of the method of the present invention;

FIG. 10 is a schematic diagram of the directory of FIG. 1;

FIG. 11 is a schematic diagram of a record database of FIG. 2;

FIG. 12 is a block diagram of the config application program of FIGS. 1, 2 and 7;

FIG. 13 is a directory menu from which a user may select a profile;

FIG. 14 is a purchase selection menu from which a plurality of products may be individually selected and purchased;

FIG. 15 is a credit information menu with which a user may provide credit account information to the computer of FIGS. 2 and 7;

FIG. 16 is a shipping information menu with which a user may provide product mailing or other delivery instructions to the computer of FIGS. 2 and 7;

FIG. 17 is a software flowchart of the computer of FIGS. 2 and 7 executing still additional certain alternate, optional or additional aspects of the method of the present invention in interaction with the server and the network of FIG. 2;

FIG. 18 is a schematic diagram of four records of FIG. 11 that are referenced by a third profile, or “gamer profile” of FIG. 10;

FIG. 19 is an illustration of a visual rendering of the gamer profile of Figure in a selection menu by the display device of the computer of FIGS. 2 and 7;

FIG. 20 is a flowchart of a method of selecting gadgets of FIGS. 2, 8 and 12 for enablement or deletion;

FIG. 21 is an illustration of a gadget selection menu of FIG. 8 that is displayed on the video screen of the computer of FIGS. 2 and 7;

FIG. 22 is a schematic of a gadget profile data structure of FIG. 2 that includes the gadget profiles;

FIG. 23 is a flowchart of a process that may be performed by the computer of FIGS. 2 and 7 in communication with the network of FIG. 8; and

FIG. 24 is a flowchart of an alternative or additional process that may be performed by the computer of FIGS. 2 and 7 in communication with the network of FIG. 8; a

FIG. 25 is a flowchart of a gadget enablement process that may be performed by the computer FIGS. 2 and 7 in communication with the network of FIG. 8 wherein the computer determines whether one or more gadgets of FIGS. 2, 8 and 12 that have been selected for access by the user require a payment authorization in order to be enabled by the computer;

FIG. 26 is an illustration of a credit data message format that may be used in the method of FIG. 25 by the computer of FIGS. 2 and 7 to transmit financial account information to the server of FIG. 8; and

FIG. 26 is an illustration of a pre-approval value record format that may be used in the method of FIG. 25 by the computer of FIGS. 2 and 7 to pre-approve use of a gadget or a software application for which a financial payment is required for access, when communication with the network and/or server of FIG. 8 is limited or impeded.

### DETAILED DESCRIPTION

In the description of this disclosure, certain terminology will be utilized for the sake of clarity. Such terminology is intended to encompass the recited aspects of the method of the present invention, as well as all technical equivalents, which operate in a similar manner for a similar purpose to achieve a similar result. Moreover, those skilled in the art will appreciate that various aspects of the invention may be practiced with other computer system configurations, including hand-held devices, gaming consoles, multiprocessor systems, microprocessor-based or programmable consumer electronics, network personal computers, minicomputers, mainframe computers, and the like. In a distributed computer environment, software programs may be located in both local and remote memory storage devices. Alternatively, aspects of the invention can be implemented in hardware or a combination of hardware, software, and/or firmware. For example, at least part of the invention could be implemented in one or more application specific integrated circuits and/or one or more programmable logic devices.

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims.

Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

In the following description, numerous specific details are set forth to provide a thorough understanding of optional, alternate and additional aspects of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one aspect” or “an aspect” means that a particular feature, structure, or characteristic described in connection with the aspect is included in at least one process or hardware configuration that is in accordance with the method of the present invention. Thus, the appearances of the phrases “in one aspect” or “in an aspect” in various places throughout this specification are not necessarily all referring to the same instantiation of the method of the present invention. Furthermore, each particular aspect of the method of the present invention, may be included in singularity or in combination in any suitable manner in one or more systems or methods.

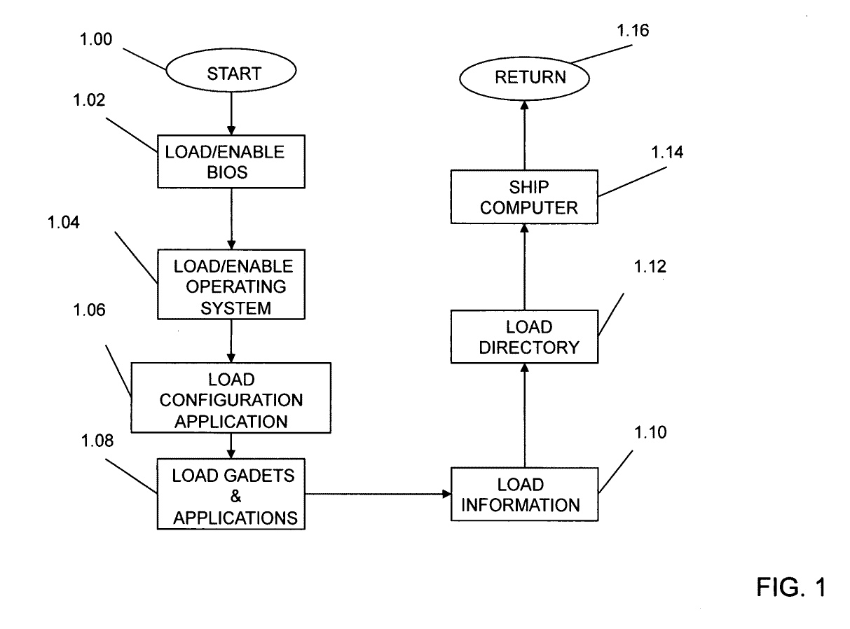

Referring now generally to the Figures and particularly to FIG. 1, FIG. 1 is a process chart of a software build of a computer 2 in accordance with certain aspects of the method of the present invention. In step 1.00 the computer 2 is powered up and in step 1.02 a basic input output system 4 (hereafter, “BIOS” 4) is enabled or loaded and enabled. An operating system 6 (hereafter, “op sys” 6 is then loaded into the computer in step 1.04 and a configuration software application 8 (hereafter, “config app” 8 is loaded into the computer 2 in step 1.06. A plurality software applications 10.A-10.N (hereafter “apps” 10.A-10.N) and gadgets 11.A-11.N are loaded into computer 2 in step 1.08 and a plurality of product and service information items 12.A-12.N (hereafter, “info” 12.A012.N) are also loaded into the computer 2 in step 1.10. A software directory 14 containing a plurality of organized and formatted user profiles 16.A-16.N and gadget profiles 17.A-17.N are loaded into the computer 2 in step 1.12. The computer 2 is shipped as a consumer electronics product in step 1.16 to either directly to a consumer or purchaser, to a retailer or wholesaler, or otherwise into the stream of commerce.

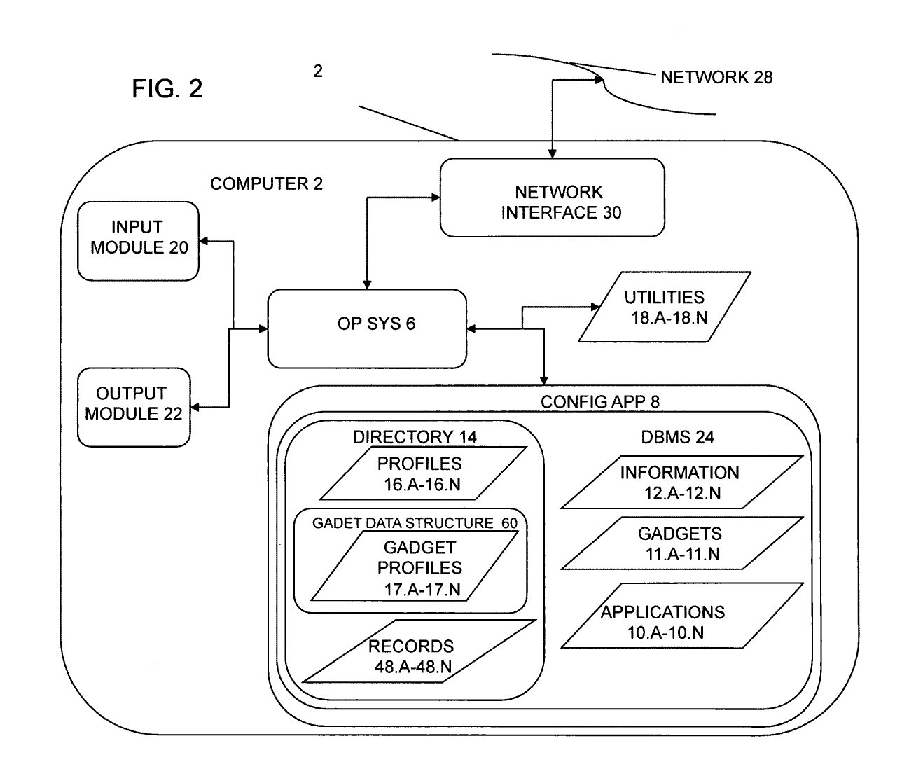

Referring now generally to the Figures and particularly to FIG. 2, FIG. 2 is a block diagram illustrating the exemplary computer 2 in accordance with certain aspects of method of the present invention. The op sys 6 is the fundamental software control program for computer 2, performing various functions including providing a user interface, managing the execution of one or more applications 10.A-10.N, gadgets 11.A-11.N and utility software programs 18.A-18.N (hereafter, “utilities” 18.A-18.N), and controlling the input of data from and output of data to various input/output (I/O) devices 20 & 22. Op sys 6 can be any of a wide variety of conventional operating systems, such as any of the “WINDOWS” operating systems available from Microsoft Corporation of Redmond, Wash.

Application programs 10.A-10.N and the gadgets 11.A-11.N represent one or more of a wide variety of software programs and web services that can be executed on computer 2 or by the computer 2 in communication with the network 28. Examples of such application programs include educational programs, reference programs, productivity programs (e.g., word processors, spreadsheets, databases), recreational programs, utility programs (e.g., communications programs), an email client, an address book, a computer security program, a web browser, a financial spreadsheet program, a software database, a software database management system, a graphics generation program, a video player, a video data editor, an audio data editor, and a calendar software. Application programs 10.A-10.N and gadgets 11.A-11.N may be pre-installed by the manufacturer or distributor of the computer 2 and enabled in response to a user command or permission as received by the computer 2. It is understood that one or more apps 10.A-10.N may comprise software code that directs the computer 2 to download a partial or entire software application, for example a remote app 10.Y, that is stored on a remote server 26 that is accessible via an electronics communications network 28 (hereafter, “network” 28).

One or more gadgets 11.A-11.N and/or applications software 10.A-10.N may enable the computer 2 to support or enable email communications, contact data recordation and access, information security, world wide web browsing, word processing, spreadsheet computation, software database access, software database management, graphics generation, video data rendering, a video data editing, an audio data editing, and a calendar data access and recordation.

It is further understood that one or more gadgets 11.A-11.N may comprise software code that directs the computer 2 to download a partial or entire gadget 11.A-11.N, for example a remote gadget 11.Y, that is stored on the remote server 26 that is accessible via the electronics communications network 28 (hereafter, “network” 28). A network interface circuit 30 (hereafter, “network I/F”) of the computer 2 bi-directionally communicatively couples the computer 2 and the network 28.

The config app 8 may wholly or partially comprise, or be wholly or partially comprised within, a database management system 24 (hereafter, “DBMS” 24). The DBMS 24 might be or comprise, in singularity or combination, (1.) an object oriented database and an Object Oriented DBMS, (2.) an IBM DB2 Universal Database™ server (in Linux, UNIX®) marketed by IBM Corporation of Armonk, N.Y.; (3.) WINDOWS™ operating system environments marketed by Microsoft Corporation of Redmond, Wash.; (4.) a relational database, such as an SQL Server Yukon™ relational database software as marketed by Microsoft Corporation of Redmond, Wash.; (5.) an Oracle Database 11 g™ relational database software as marketed by Oracle Corporation of Redwood Shores, Calif.; and/or (6.) multiple data sources to which the client query application sends queries.

The computer 2 and/or the remote server 26 may be may be selected from a group of suitable electronic devices known in the art, including (1.) a Nokia Model E61™ cellular telephone marketed by Nokia Corporation of Espoo Finland; (2.) a BLACKBERRY™ wireless personal digital assistant marketed by Research-in-Motion of Waterloo, Ontario, Canada; (3.) a VAIO FS8900™ notebook computer marketed by Sony Corporation of America, of New York City, N.Y.; (4.) POWERBOOK G4™ personal computer marketed by Apple Computer, Inc., of Cupertino, Calif.; or (5.) an iPhone™ cellular telephone marketed by Apple Computer, Inc., of Cupertino, Calif.

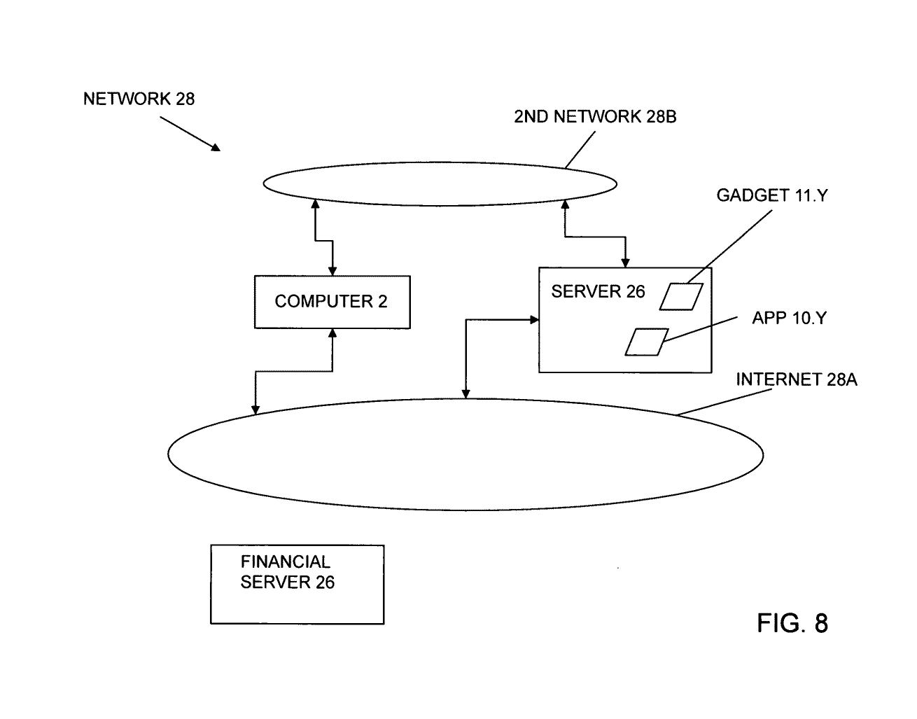

As illustrated in FIG. 8, the network 28 may be, comprise in whole or in part, or be comprised in whole or in part within, the Internet 28A and/or a second electronics communications network 28B. The second electronics network 28B may be or comprise, in whole or in part, an intranet, an extranet, an electronic computer network, a telephony system, a wireless telephony system, and/or a wireless electronics communications network, wherein the network I/F 30 is configured to enable electronic communications with the Internet 28A and/or the second electronics communications network 28B.

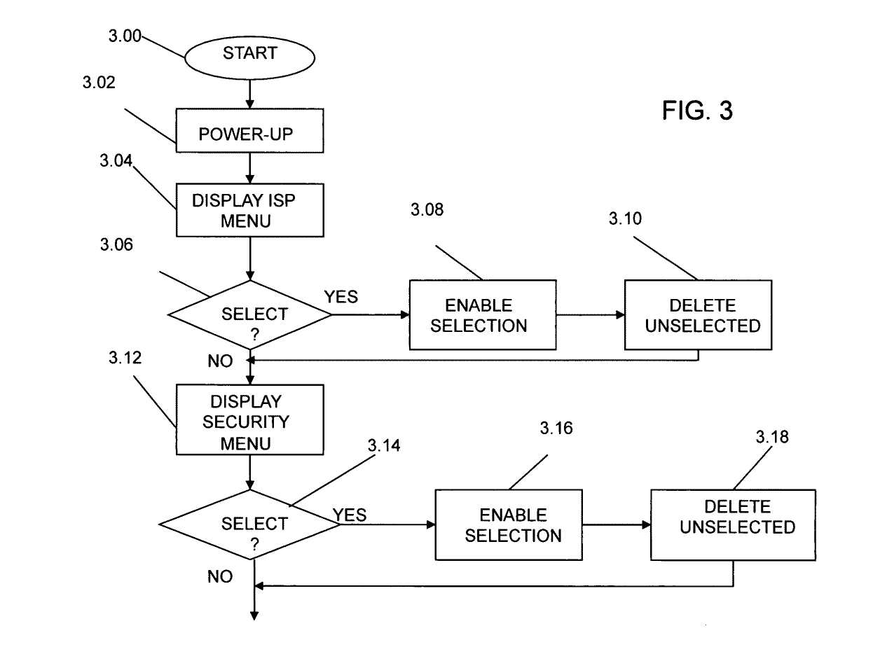

Referring now generally to the Figures and particularly to FIG. 3, FIG. 3 is a software flowchart of a process whereby the computer 2 of FIGS. 2, 7 and 8 may implement certain aspects of the method of the present invention. In step 3.02 of the method of FIG. 3 (hereafter, “first method”), the computer 2 is powered up and an ISP selection menu presenting Internet service providers is displayed via a video display screen 22A of a display device 22B of the output module 22. When a user selects an Internet service provider in step from 3.06 from the ISP selection menu, the computer 2 proceeds from step 3.06 to step 3.08 to enable the selection, i.e., execute an ISP software registration program. The user may select an ISP registration program in step 3.06 by means of a point and click selection device, e.g., a computer mouse 20A and/or a computer keyboard 20B of the input module 20. In optional step 3.10 ISP registration software program(s) not selected in step 3.06 are deleted from the computer 2.

In step 3.12 the computer 2 is powered up and a security software selection menu presenting security software choices is displayed via a video display screen 22A the output module 22. When a user selects an Internet service provider in step from 3.12 from the security software selection menu, the computer 2 proceeds from step 3.14 to step 3.16 to enable the selection, i.e., execute a security software program. The user may select a security software program in step 3.14 also by means of a point and click selection device, e.g., a computer mouse 20A and/or a computer keyboard 20B of the input module 20. In optional step 3.18 computer software program(s) not selected in step 3.14 are deleted from the computer 2.

It is understood that the ISP registration programs and the computer security programs respectively of steps 3.04 through 3.10 and steps 3.12-3.18 may be comprised within the apps 10.A-10.N. ISP registration programs include software that enables an account registration with (1.) America OnLine™ Internet service provider; (2.) Earthlink™ Internet service provider; and other suitable Internet Service provider registration software known in the art. Computer security software that may be referred to in the security software menu of step 3.12 may include (1.) McAfee VirusScan™ anti-virus software as marketed by McAfee Corporation of Santa Clara, Calif.; (2.) SpySweeper™ spy ware detector as marketed by Webroot Software, Inc. of Boulder Colo.; (3) and other suitable computer security software programs and products known in the art.

In the first version the computer 2 proceeds from either step 3.14 or step 3.18 to step 4.02.

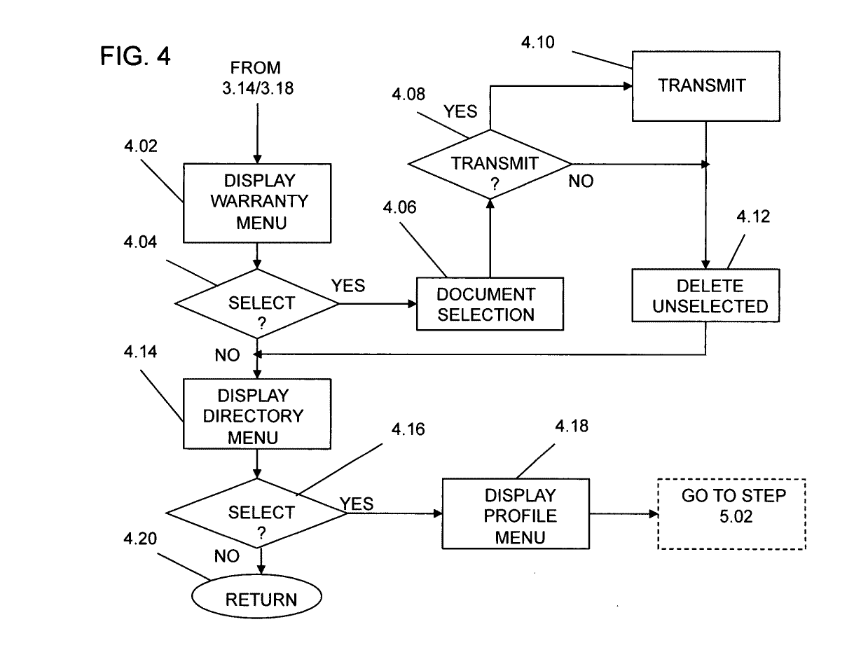

Referring now generally to the Figures and particularly to FIG. 4, Figure is a software flowchart of a process whereby the computer 2 of FIGS. 2, 7 and 8 may implement certain other aspects of the first method. In step 4.02, the computer 2 a warranty selection menu presenting two or more warranty agreements is displayed via a video display screen 22A the output module 22. When the user selects a warranty form the warranty agreement selection menu, the computer 2 proceeds from step 4.04 to step 4.06 document and record the warranty selection. The user may select a warranty agreement in step 4.04 by means of a point and click selection device, e.g., the computer mouse 20A and/or the computer keyboard 20B of the input module 20. In optional step 4.08 the computer 2 determines whether the computer 2 is presently communicatively linked with the server 26 via the network 28. When the computer 2 determines that it is presently in communication with the server 26, the computer 2 transmits information regarding the instant warranty agreement of step 4.04 to the server 26 and via the network 28 in step 4.10. In optional step 4.12 one or more warranty agreements not selected in step 4.04 are deleted from the computer 2.

In step 4.14 the computer 2 is powered up and a profile selection menu presenting profile choices is displayed via a video display screen 22A the output module 22. When a user selects a profile 16.A-16.N in step from 4.16 from a directory selection menu MENU.DIR, the computer 2 proceeds from step 4.16 to step 4.18 to display a purchase selection menu MENU.PRO.

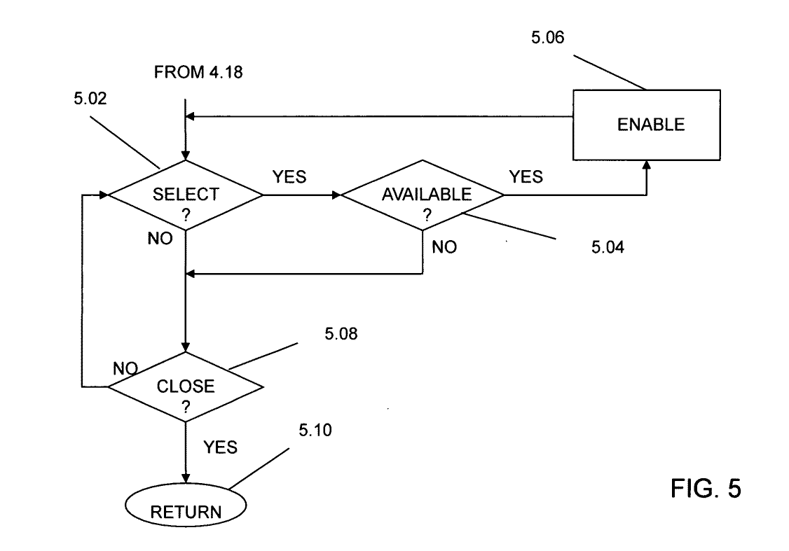

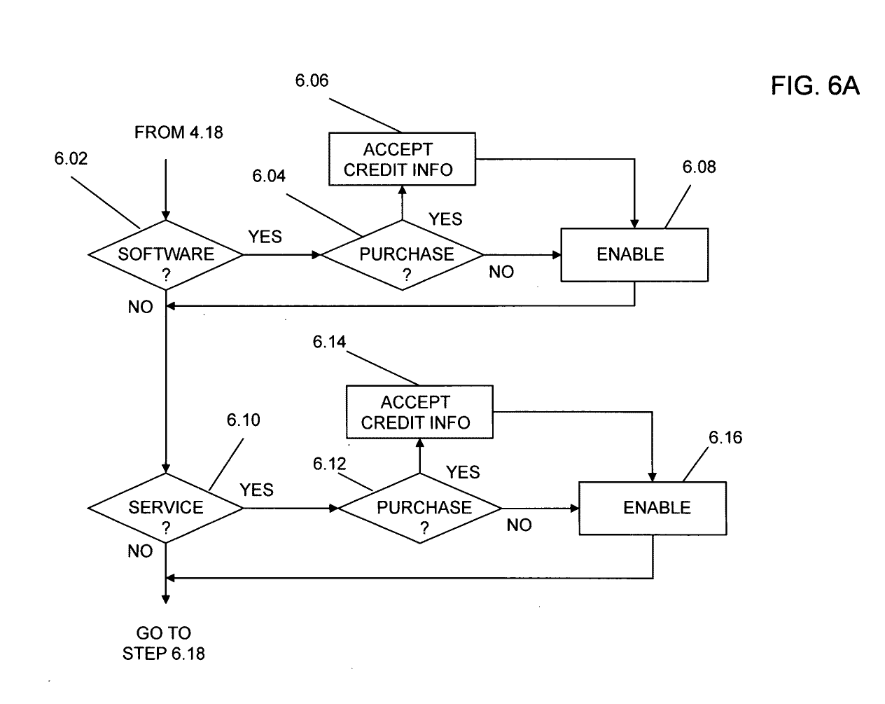

FIG. 5 is a software flowchart of a process whereby the computer 2 of FIGS. 2, 7 and 8 may implement certain yet other aspects of the first method. The computer 2 determines in step 5.02 whether the user has selected an option from the purchase selection menu MENU.PRO of step 4.18. When the computer 2 determines in step 5.02 that the user has selected an applications program 10.A-10.N from the purchase selection menu MENU.PRO, the computer 2 proceeds on to step 5.04 to determine if the applications program 10.A-10.N selected in step 5.02 is locally stored and available for installation and/or execution by the computer 2. When the computer 2 determines in step 5.04 that the applications program 10.A-10.N selected in step 5.02 is available for installation and/or execution, the computer 2 proceeds from step 5.04 to step 5.06 and to enable the user to run the selected program 10.A-10.N.

The computer 2 determines in step 5.08 whether the user wishes to close the purchase selection menu MENU.PRO of step 4.18 or to return to other computational process by proceeding onto step 5.10.

Referring now generally to the Figures and particularly to FIGS. 6A and 6B, FIGS. 6A and 6B are software flowcharts of a process whereby the computer 2 of FIGS. 2, 7 and 8 and the electronic communications network 28 of FIG. 8 may implement certain a second alternate method (hereafter, “second method”) that instantiates or employs yet other aspects of the present invention.

The computer 2 determines in step 6.02 whether the user has selected an option to enable an applications program 10.A-10.N from the purchase selection menu MENU.PRO of step 4.18. When the computer 2 determines in step 6.02 that the user has selected an applications program 10.A-10.N from the purchase selection menu MENU.PRO, the computer 2 proceeds on to step 6.04 to determine if the applications program 10.A-10.N shall be purchased prior to enablement, I.e., installation or execution of the instant selected applications program 10.A-10.N. When purchase is required, the computer 2 accepts credit-billing information in step 6.06 and the selected applications program 10.A-10.N is enabled for installation and/or execution by the computer 2 in step 6.08.

The computer 2 determines in step 6.10 whether the user has selected an option to enable an applications program 10.A-10.N that enables web service or other communications network based service from the purchase selection menu MENU.PRO of step 4.18. When the computer 2 determines in step 6.10 that the user has selected a service applications program 10.A-10.N from the purchase selection menu MENU.PRO, the computer 2 proceeds on to step 6.14 to determine if enablement of the instant network-based service applications program 10.A-10.N shall be purchased prior to enablement, i.e., installation or execution of the instant selected network based service applications program 10.A-10.N. When purchase is required, the computer 2 accepts credit-billing information in step 6.14 and the selected network-based service applications program 10.A-10.N is enabled for installation and/or execution by the computer 2 in step 6.16.

Referring now generally to the Figures and particularly to FIG. 6B, the computer 2 determines in step 6.18 whether the user has selected an option to purchase a hardware product from the purchase selection menu MENU.PRO of step 4.18. It is understood that the hardware product is not necessarily a computer related product, but may be another good that is typically physically delivered to a purchaser to fulfill a sale.

When the computer 2 determines in step 6.18 that the user has selected a hardware purchase option from the purchase selection menu MENU.PRO, the computer 2 proceeds on to step 6.20 to determine if the selected hardware item is offered at no charge or shall be purchased prior to shipment. When purchase before shipment of the hardware item is required, the computer 2 accepts credit-billing information in step 6.20. In addition, the computer 2 accepts delivery/mailing address information in step 6.24

The computer 2 determines in step 6.26 whether the computer 2 attempts to initiate a communications session with the remote server 26. When a communications session is successfully initiated in step 6.26, the computer 2 transmits ordering, billing and mailing/address information previously collected in steps 6.02 through 6.24 to the server 26 in step 6.38.

The computer 2 determines in step 6.30 whether any pending purchases previously requested by the user have been approved or disapproved by the server 26. In optional step 6.32 the earlier accomplish enabling by the computer 2 of previously selected applications software programs 10.A-10.N, the purchase of which has been declined by the server 26, are disabled.

It is understood that in certain even other alternate preferred aspects of the method of the present invention enablement of an applications program 10.A-10.N that requires purchase might not be permitted until the server 26 approves a purchase of the selected applications program 10.A-10.N.

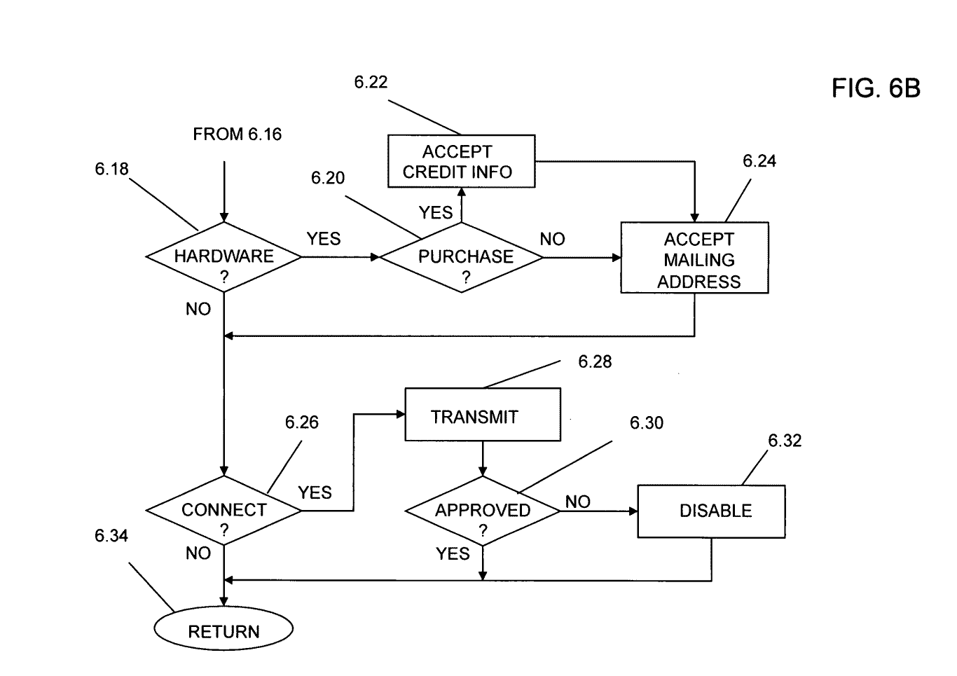

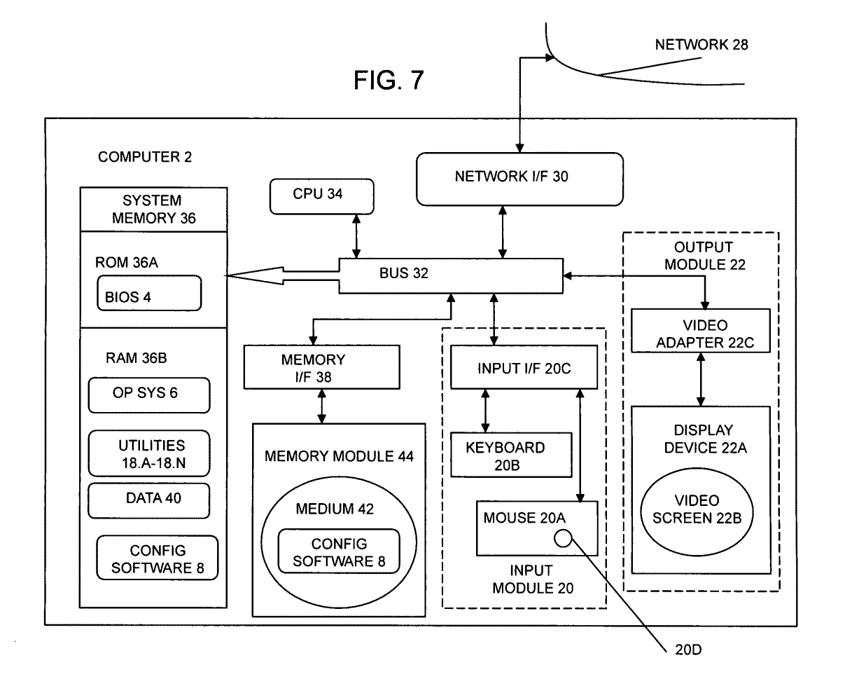

Referring now generally to the Figures and particularly to FIG. 7, FIG. 7 is a detailed schematic of the computer 2 of FIG. 2. It is understood that the server 26 may include one or more of the aspects and elements of the computer 2. The computer 2 includes an internal communications bus 32 that bi-directionally communicatively couples a central processing unit 34 (or CPU” 34), a system memory 36, a computer-readable memory interface 38, the input module 20, the output module 22 and the network I/F 30. The BIOS 4 is stored in an optional read-only memory portion 36A of the system memory 36, and a random access memory portion 36B of the system memory 36 stores the OP sys 6, the plurality of utilities 18.A-18.N, a plurality of data 40, and the config software 8. It is understood that the config software 8 may be stored in whole or in part, or in duplication within the system memory 36 and within a computer-readable medium 42 of a memory module 44. The memory interface 38 may be a memory interface 38 that enables the CPU 34 to retrieve software code of the config software 8 from the memory module 44 in a case wherein the memory module is or comprises a disc drive 44 and the memory medium 42 is a memory disc 42. The memory disc 42 may be an optical or magnetic digital information storage medium, and the disc drive 44 and the memory interface 38 are selected and configured to enable the CPU 34 to access information stored on a memory disc 42.

An input module interface 20C of the input module 20 is bi-directionally communicatively coupled with the bus 32 and is configured to (a.) accept outputs from the keyboard 20B and the mouse 20A, and (b.) translate and transmit the mouse and keyboard initiated signals to the bus 32 for interpretation by the CPU 34 as commands and information. A video adapter 22C of the output module 22 is bi-directionally communicatively coupled with the bus 32 and is configured to accept video data from the bus 32 and present images derived therefrom to the user by means of the video screen 22B of the display device 22A.

In certain alternate configurations of the computer 2, and in accordance with certain optional, alternate or additional aspects of the method of the present invention, the disk drive 44 and/or the system memory 36 is or comprises, computer-readable non-volatile media, and/or volatile media that includes machine readable instructions that direct the computer 2 to instantiate one or more aspects of the method of the present invention by automatic processing and/or by interaction with the user and/or the network 28.

Non-volatile media includes, for example, optical or magnetic disks, tapes and thumb drives. Volatile media includes dynamic memory. Common forms of computer-readable media include, for example, solid state electronic memory, a floppy disk, a flexible disk, a hard disk, a magnetic tape, or any other magnetic medium, a CD-ROM, any other optical medium, RAM, a PROM, and EPROM, a FLASH-EPROM, or any other memory chip or cartridge as described hereinafter, or other suitable medium known in the art from which a computer can read machine executable instructions.

Referring now generally to the Figures and particularly to FIG. 8, FIG. 8 is a block diagram of the network 28 by which certain aspects of the first method, the second method, and certain other alternate preferred aspects of the method of the present invention may be practiced. As disclosed previously herein, the network 28 may be, comprise in whole or in part, or be comprised in whole or in part within, the Internet 28A and/or a second electronics communications network 28B. The second electronics network 28B may be or comprise, in whole or in part, an intranet, an extranet, an electronic computer network, a telephony system, a wireless telephony system, and/or a wireless electronics communications network, wherein the network I/F 30 is configured to enable electronic communications with the Internet 28A and/or the second electronics communications network 28B.

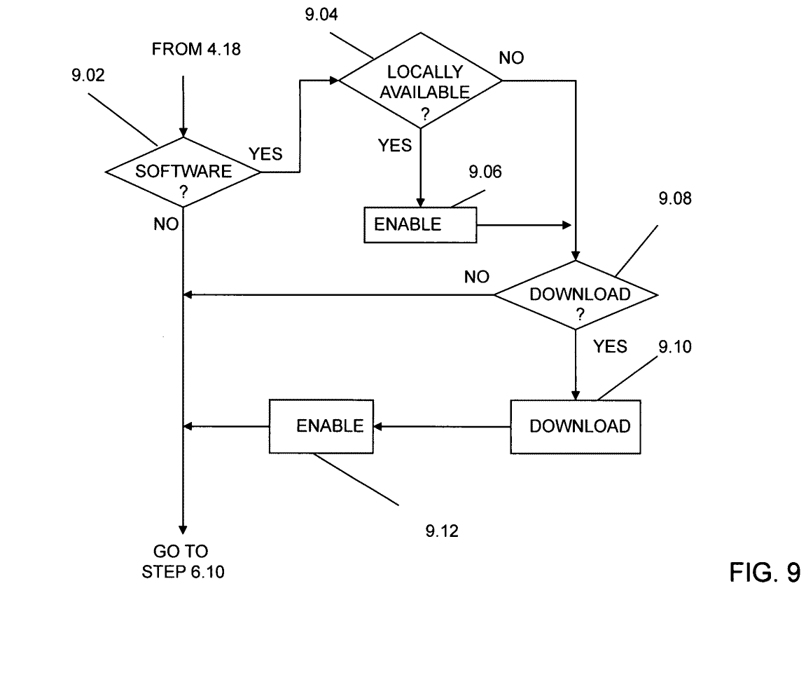

Referring now generally to the Figures and particularly to FIG. 9, FIG. 9 is a software flowchart of still other aspects of the method of the present invention. The computer 2 determines in step 9.02 whether the user has selected an option to enable an applications program 10.A-10.N selected from the purchase selection menu MENU.PRO of step 4.18. When the computer 2 determines in step 9.02 that the user has selected an applications program 10.A-10.N from the purchase selection menu MENU.PRO, the computer 2 proceeds on to step 9.04 to determine if part or all of the applications program 10.A-10.N is locally stored and available on the computer 2. When the computer 2 determines in step 9.04 that part or all of the applications program 10.A-10.N of step 9.02 is at least partially locally stored and available, the computer 2 installs, runs and/or enables the instant applications program 10.A-10.N in step 9.06. The computer 2 proceeds from either step 9.04 or 9.06 to step 9.08 to determine whether part or all of the instant applications program 10.A-10.N is available for download from the remote server 26, or elsewhere in the network 28. When a download requirement and opportunity is determined in step 9.08, the computer 2 proceeds from step 9.08 to download all or part of the selected applications program 10.A-10.N in step 9.10. The downloaded software code of the applications program downloaded in step 9.10 is installed and made available for execution in step 9.12. It is understood that one or more applications programs 10.A-10.N may be partially stored locally and enabled in step 9.06, and partially downloaded in part in step 9.10, to enable a full installation and execution of the instant applications program 10.A-10.N in step 9.12.

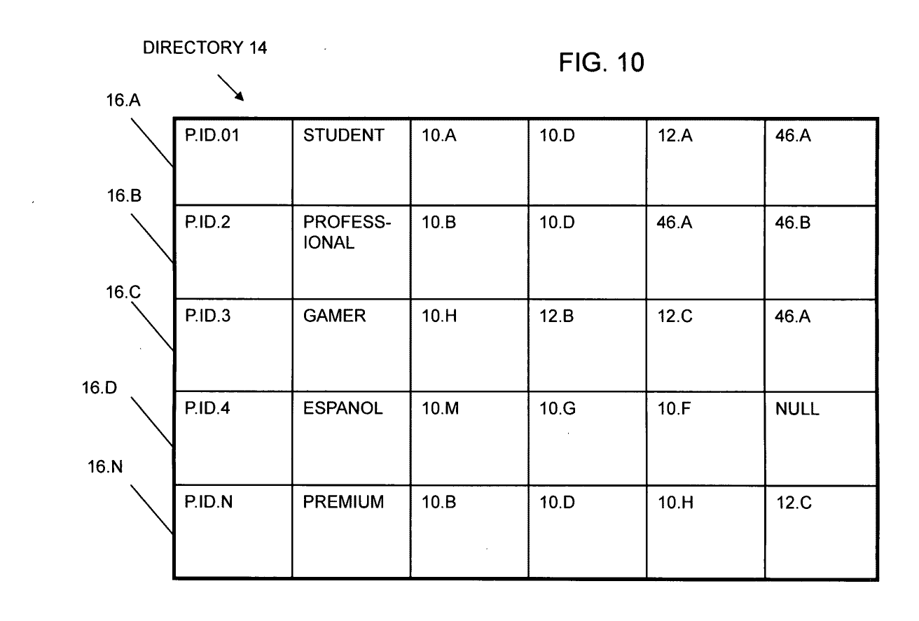

Referring now generally to the Figures and particularly to FIG. 10, FIG. 10 illustrates on aspect of the directory 14 wherein the profiles 16.A-16.N are stored. Each profile 16.A-16.N includes a profile identifier P.ID.01-P.ID.N that enables the computer 2 to distinguish each profile 16.A-16.N as a unique profile 16.A-16.N. Each profile 16.A-16.N also includes a title, e.g., STUDENT for the first profile 16.A, PROFESSIONAL for the second profile 16.B, GAMER for the third profile 16.C, ESPANOL for the fourth profile 16.D, and PREMIUM for the nth profile 16.N. These titles are displayed on the profile screen, x as rendered by the output module 22.

Each profile 16.A-16.N further includes identifiers of applications programs 10.A-10.N, information 12.A-12.N and network service enabling software 46.A-46.N that are referenced by, and made available for use in learning about, purchasing or selecting products and services, when the comprising profile 16.A-16.N is (a.) selected by the user and (b.) visually represented by the output module 22.

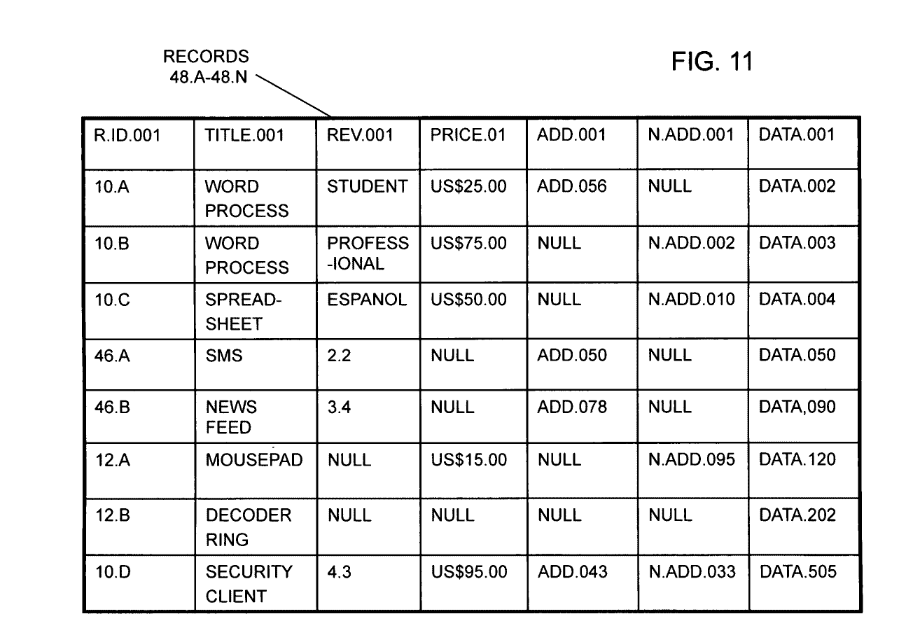

Referring now generally to the Figures and particularly to FIG. 11, FIG. 11 is a block diagram of software records 48.A-48.N that are accessed by the method of the present invention to locate and enable the display and/or execution of applications program 10.A-10.N, network service software 46.A-46.N, and product information 12.A-12.N. A plurality of record 48.A-48.N are individually represented as a row of data in FIG. 11, wherein each record 48.A-48.N includes an identifier, e.g., 10.A, 46.B, and 12.A and a title or product name, e.g., WORD PROCESS, NEWSFEED, and MOUSEPAD. Each record 48.A-48.N further includes a revision level, e.g., REV.001, STUDENT, and PROFESSIONAL. The price of a good or service may also be included in a record 48.A-48.N. A record 48.A-48.N may also include a local address of the host computer 2 where the software identified by the identifier may be read from, e.g., the first applications program 10.A may be read from a starting address of ADD.056 of the host computer's system memory 36, and a first service software 46.A may be read from a starting address of ADD.050 of the host computer's system memory 36. Additionally or alternatively, a record 48.A-48.N may contain a network address, e.g., N.ADD.002, N.ADD.010, from which some or all of a software program referenced in the instant record 46.A-46.N may be downloaded. For example, the SPREADSHEET software identified as the third applications program 10.C, and localized for Spanish speakers, may be downloaded from a network address of N.ADD.010 of the network 28. In addition, data stored for presentation to the user in reference to the software, product, or service identified in a same record 48.A-48.N may be included in a record 48.A-48.N and visually rendered by the output module 22. For example an information DATA.202 describing how to use the DECODER RING product referenced by the host computer 2 as a second product information 12.B may be stored, cross-referenced and identified in a same record 48.A-48.N.

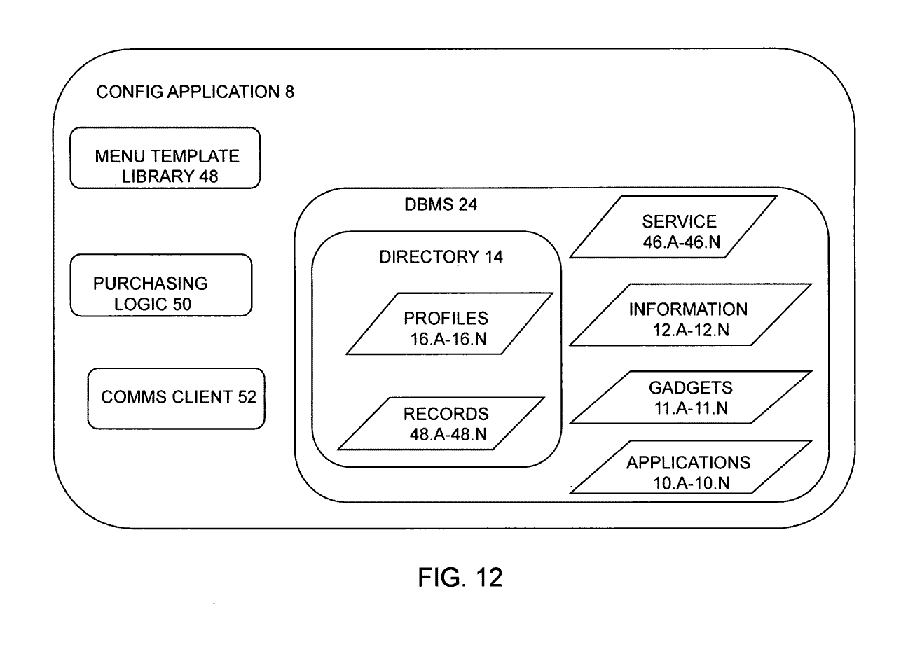

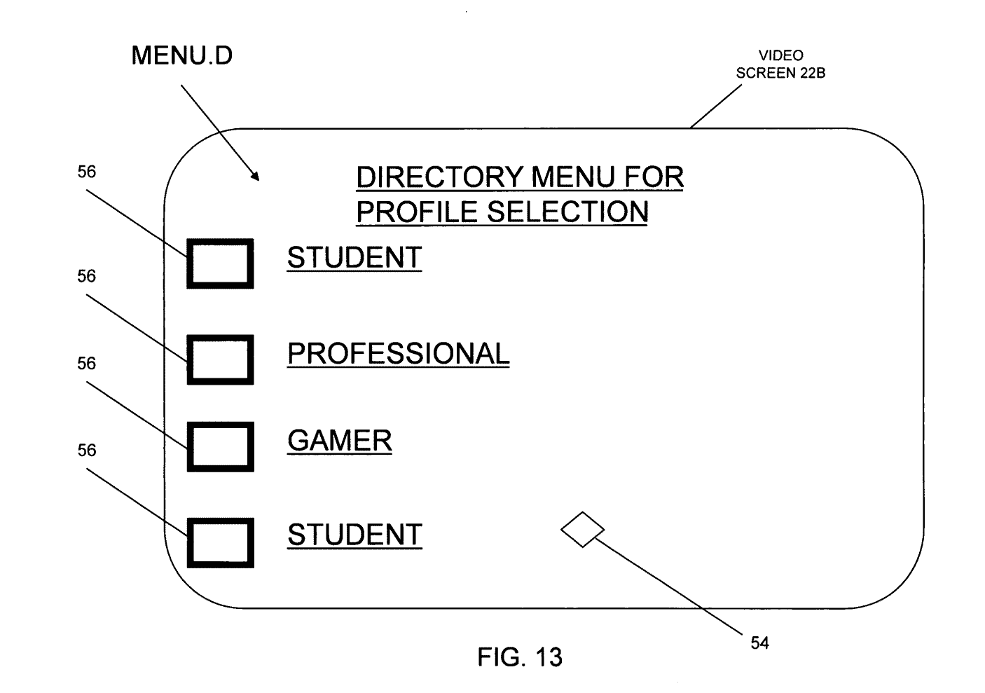

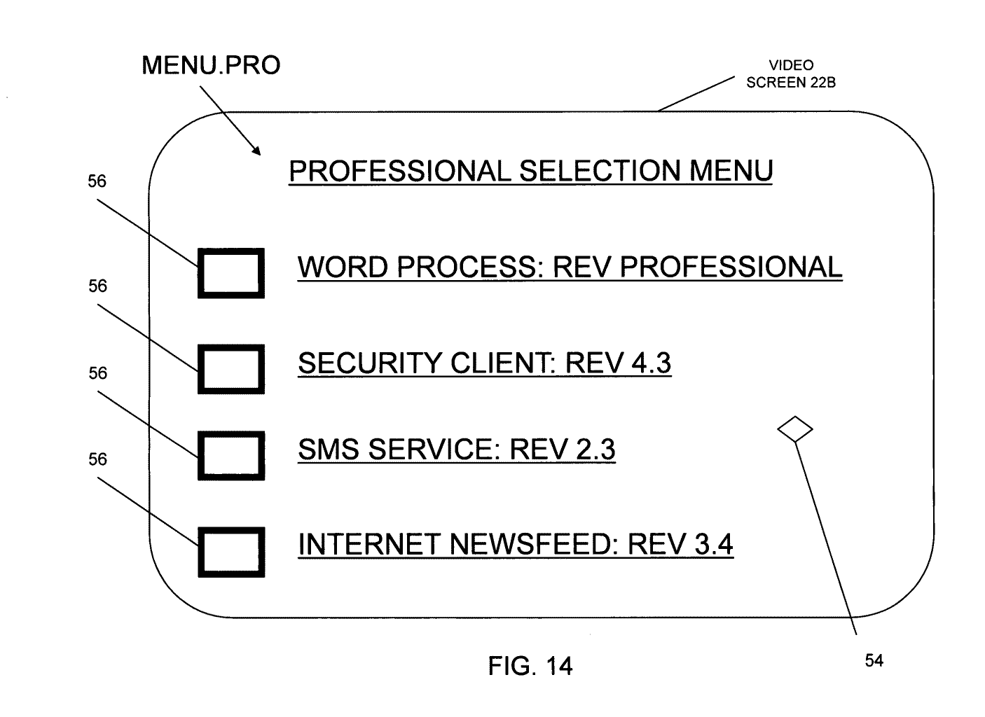

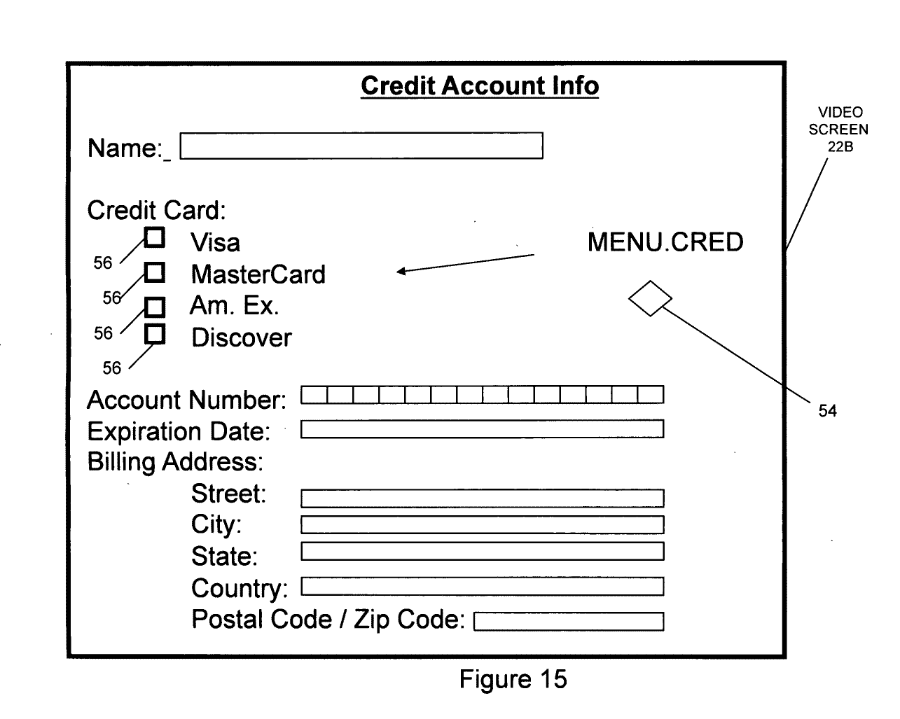

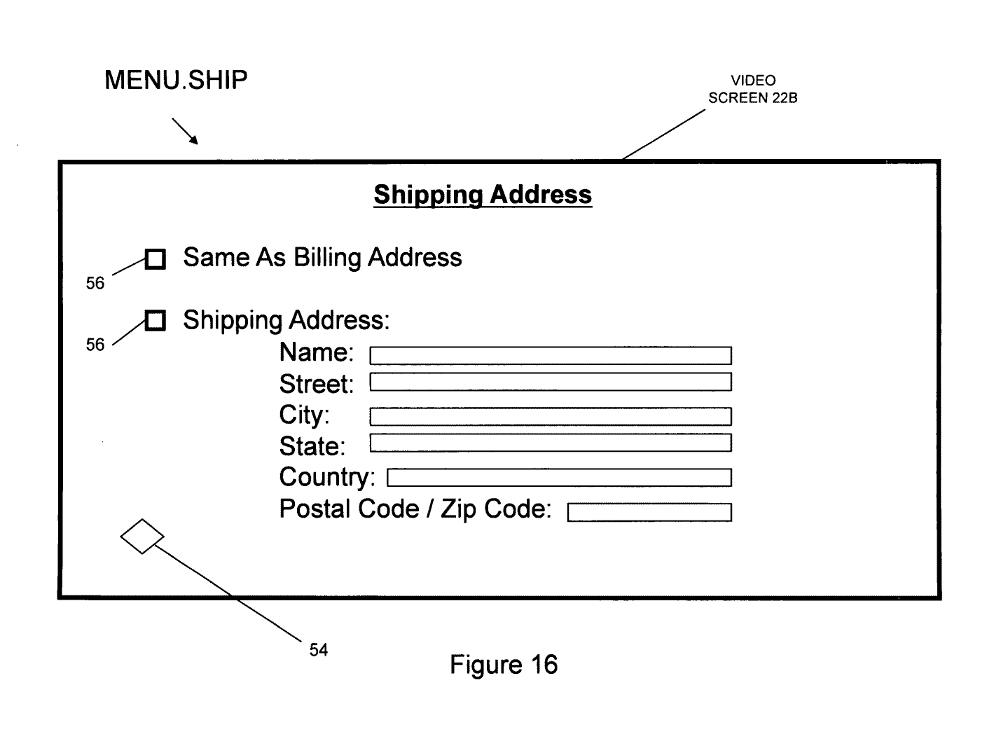

Referring now generally to the Figures and particularly to FIG. 12 is block diagram of the config application 8 of FIG. 2. The config application 8 includes a software menu template 48, a purchasing logic 50, a communications client 52, and the DBMS 24. The menu template 48 includes the software and encoded logic to enable the output module to visually display various selection menus, such as the directory menu MENU.DIR of FIG. 13, the profile selection menu MENU.PRO of FIG. 14, the ISP selection menu (not shown), the computer security software (not shown), and the credit purchase menu MENU.CRED of FIG. 15 and the shipping information menu MENUSHIP of FIG. 16. The purchasing logic 50 enables the formatting of messages for transmission to the server 26 that includes credit account information and shipping addresses. The communications software client 52 enables the transmission via the network I/F 30 and the network 28 to the server 26 of credit information and shipping information; as well as requests to download applications programs 10.A-10.N in whole or in part.

Referring now generally to the Figures and particularly to FIG. 13, FIG. 13 is a directory menu from which a user may select a profile 16.A-16.N. The first profile 16.A may be selected by the user by mean of applying the computer mouse 20 A to (a.) position the cursor 54 into or over the selection icon 56 most proximate to a visual representation of a title of the desired profile, e.g., STUDENT, PROFESSIONAL; and (b.) then clicking a selection button 20D of the mouse 20A.

Referring now generally to the Figures and particularly to FIG. 14, FIG. 14 is a professional purchase selection menu MENU.PRO from which a plurality of products may be individually selected and purchased. The choices of products and services offered by the “professional” selection menu MENU.PRO are derived from the second profile 16.B. A product or service may be selected for purchase, registration or use by the user by mean of applying the computer mouse 20 A to (a.) position the cursor 54 into or over the selection icon 56 most proximate to a visual representation of a title of the desired product, e.g., WORD PROCESS, SMS SERVICE; and (b.) then clicking a selection button 20D of the mouse 20A.

Referring now generally to the Figures and particularly to FIG. 15, FIG. 15 is a credit information menu with which a user may provide credit account information to the computer 2. The user may use the keyboard to fill out the relevant data fields to provide a credit account number, an associated account holder name, an account expiry date thereof, and an associated billing address of the credit account. The user may identify a credit account type by (a.) using the mouse 20A to position the cursor 54 into or over the selection icon 56 most proximate to a visual representation of a credit account type; and (b.) then clicking a selection button 20D of the mouse 20A.

FIG. 16 is a shipping information menu with which a user may provide product mailing or other delivery instructions to the computer 2 by use of the computer mouse 20A and the computer keyboard 20B.

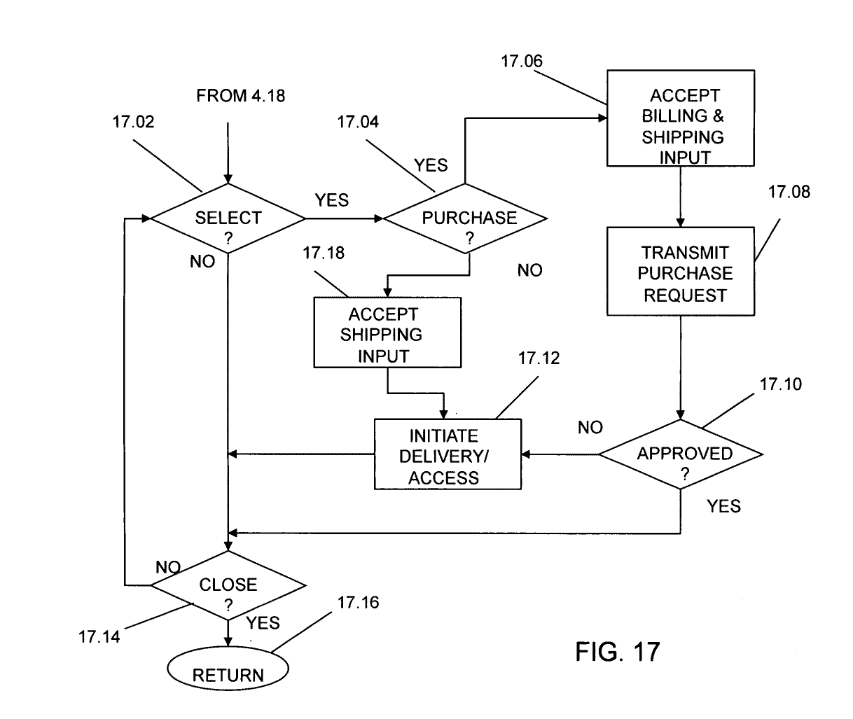

Referring now generally to the Figures and particularly to FIG. 17, FIG. 17 is a software flowchart of the computer executing still additional aspects of the method of the present invention 7 in coordination with the server and the network of FIG. 2. In step 17.02 the computer 2 determines whether the user has selected a product or service from a selection, e.g., MENU.PRO or other purchase selection menu as derived from another profile 16.A-16.N. When the computer determines in step 17.02 that the user has selected a product or service, the computer 2 proceeds from step 17.02 to step 17.04 to determine whether the selected product or service shall be purchased. When the computer 2 determines in step 17.04 that the selected product or service shall be purchased, the computer proceeds from step 17.04 to step 17.06 and to request and receive billing and shipping information. In step 17.08 the computer 2 formats and transmits a purchase request to the server 26 via the network 28. The computer 2 determines in step 17.10 whether approval of the purchase request has been received. When the computer 2 determines in step 17.10 that approval of the purchase request has been received from the server 26 and via the network 28, the computer 2 proceeds from step 17.10 to step 17.12 to initiate a delivery or enablement process for the client. The execution of step 17.12 may include (a.) enabling access by the user to an applications program 10.A-10.N residing within the computer 2; (b.) initiating a download of a remotely stored applications program 10.Y; and/or (c.) initiating a postal service package mailing process.

When the computer 2 determines in step 17.10 that approval of the purchase request has not been received from the server 26 or via the network 28, the computer 2 does not initiate a delivery or enablement process of step 17.12, but rather proceeds from step 17.10 to step 17.14 to determine whether to either (a.) close the selection menu MENU.PRO and proceed onto other computational processing of step 17.16; or (b.) to return to step 17.02.

It is understood that a null value in a price data field of a record 48.A-48.N indicates that the product or service associated with the same record 48.A-48.N comprising said null price value does not require purchase, and that access to, or a delivery process of, may be initiated merely by selecting the instant product or service, in which cases the computer 2 proceeds directly from step 17.04 to step 17.18.

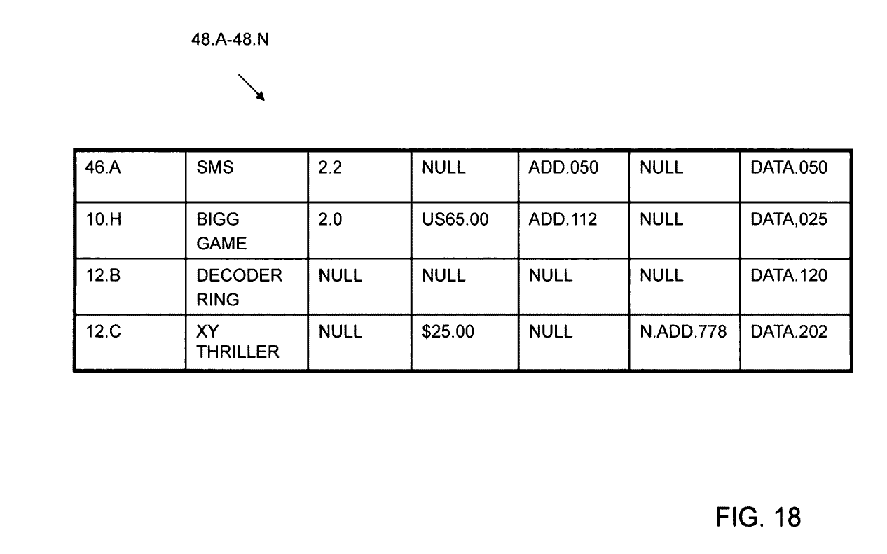

Referring now generally to the Figures and particularly FIG. 18, FIG. 18 is a schematic diagram of four records 48.A-48.N that are referenced by the third profile 16.C, or “gamer profile” 16.C. The gamer profile 16.C enables the computer 2 to offer, alternately for purchase, acquisition or subscription, (a.) a short next message service (as per 46.A), an electronic media product bearing a title of BIGG GAME (as per 10.H); a no-charge decoder ring (as per 12.B); and an electronic media product with software encoding of a movie feature entitled XY THRILLER (as per 12.C). The SMS service of 46.A may be subscribed to at no initial charge and by executing a registration client that is located at an address ADD.050 of the system memory 36 of the computer 2. The media of 10.H bearing a software game product entitled BIGG GAME may be purchased for $65.00 and by executing a purchase request client that is located at an address ADD.112 of the system memory 36 of the computer 2. The DECODER RING product of 12.B may be acquired without payment by the user's accessing a data DATA.120 and mailing a letter in accordance with the instructions of the data DATA.120 via a postal service. The media of 12.C bearing the entertainment product entitled XY THRILLER may be purchased for $25.00 by the computer 2 initiating a communications session with a server 26 at network address N.ADD.778 of the network 26 and transmitting a purchase request with valid credit account and shipping information to the server 26.

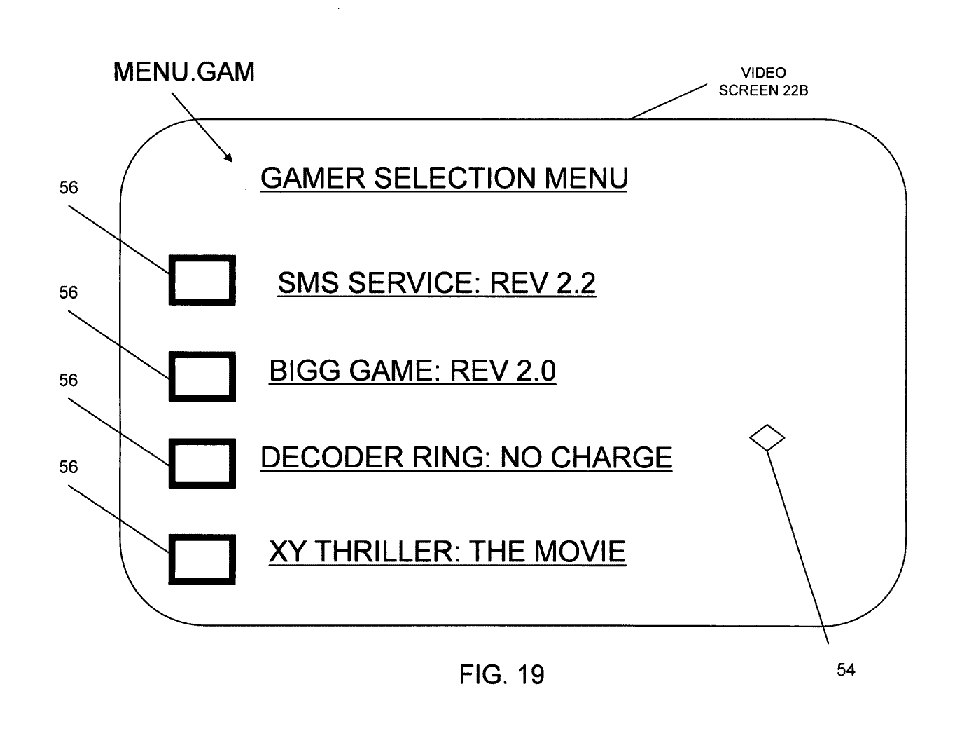

Referring now generally to the Figures and particularly to FIG. 19, FIG. 19 is a purchase gamer selection menu MENU.GAM from which a plurality of products may be individually selected and purchased. The choices of products and services offered by the gamer selection menu MENU.GAM are derived from the third profile 16.C. As described above, a product or service may be selected for purchase, registration or use by the user by mean of applying the computer mouse 20 A to (a.) position the cursor 54 into or over the selection icon 56 most proximate to a visual representation of a title of the desired product, e.g., WORD PROCESS, SMS SERVICE; and (b.) then clicking a selection button 20D of the mouse 20A.

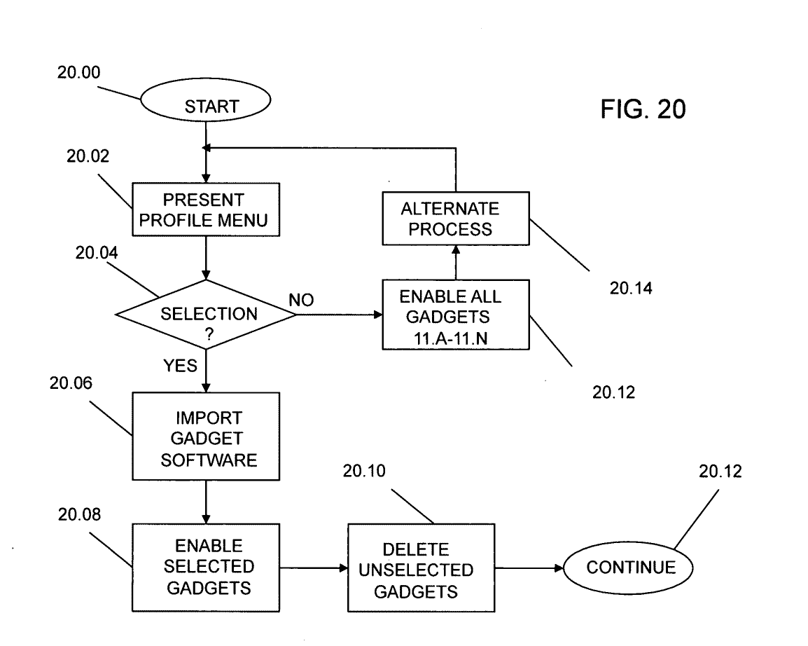

Referring now generally to the Figures and particularly FIG. 20, FIG. 20 is a flowchart of a method of selecting gadgets 11.A-11.N for enablement or deletion. The gadgets 11.A-11.N are stored within the DBMS 24 and the DBMS is stored, modified, updated, accessed from and maintained within the system memory 36. It is understood that one or more gadgets 11.A-11.N when enabled may direct the computer 2 to enable or download one or more applications 10.A-10.N and/or initiate one or more web services available via the network 28.

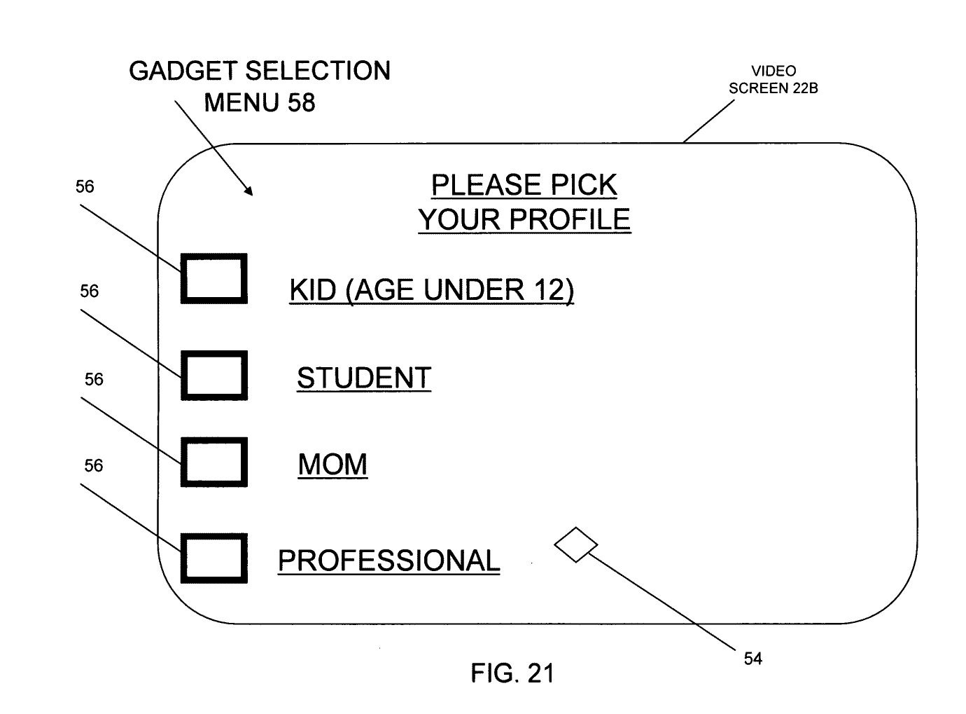

In step 20.02 the computer 2 visually presents a gadget profile menu 21 of FIG. 21 on the video screen 22B and enables the user to select a gadget profile 17.A-17.D.

The computer 2 determines in step 20.04 whether the user has made a gadget profile selection in step 20.02. When the computer 2 determines in step 20.04 that the user has made a gadget profile selection in step 20.02, the computer 2 proceeds from step 20.04 to optional step 20.6 to import some or all of one or more gadget software of the gadgets associated with one or more profiles selected in step 20.02. The software importation of step 20.06 is accomplished by uploading from the computer-readable medium 42 and/or the network 28 in singularity or in combination, wherein a private or public encryption key may be transferred to and/or from the computer 2 and the network 28 and/or computer-readable medium 42.

Upon proceeding from step 2.06 to step 20.08, the computer 2 enables all gadgets 11.A-11.N referenced within a gadget profile 17.A-17.D selected in step 20.02. In optional step 20.10 the computer 2 deletes all gadgets 11.A-11.N that were not enabled in step 20.06. The computer 2 proceeds from step 20.08 to step 20.12 and to execute alternate computational processes.

When the computer 2 determines in step 20.04 that the user has not made a gadget profile selection in step 20.02, the computer 2 proceeds from step 20.04 to optional step 20.08 and to enable all gadgets 11.A-11.N. The computer 2 may proceed from step 20.04 or step 20.12 to step 20.14 and to execute alternate computational processes.

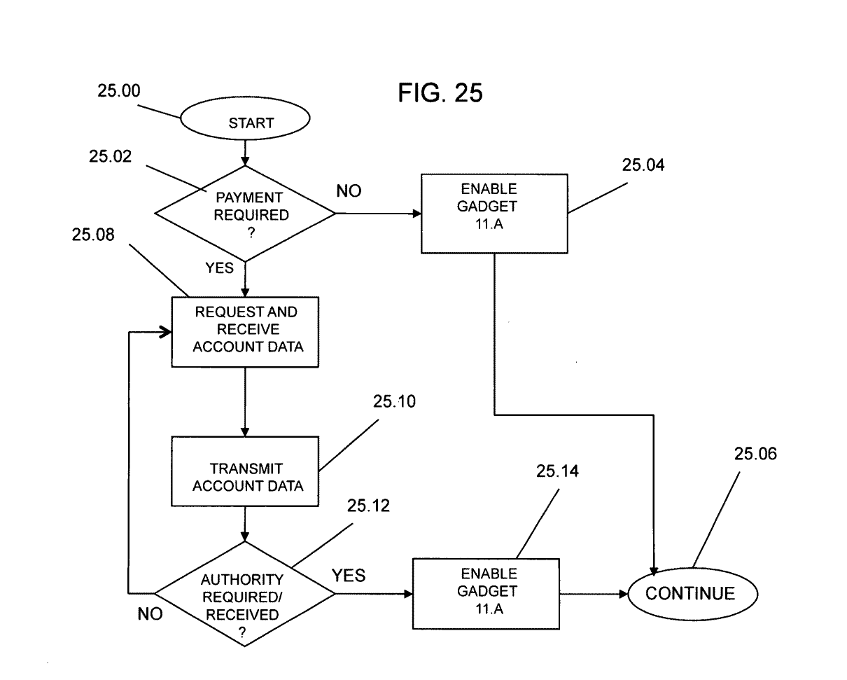

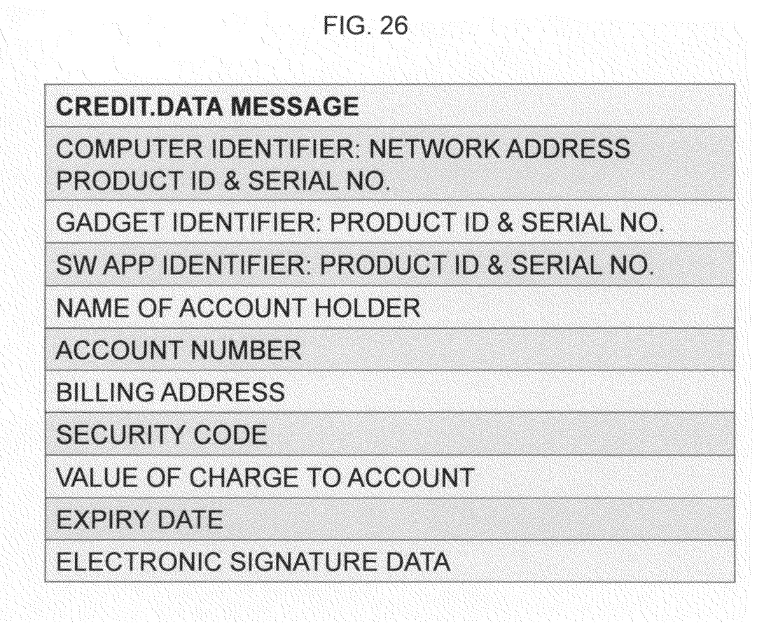

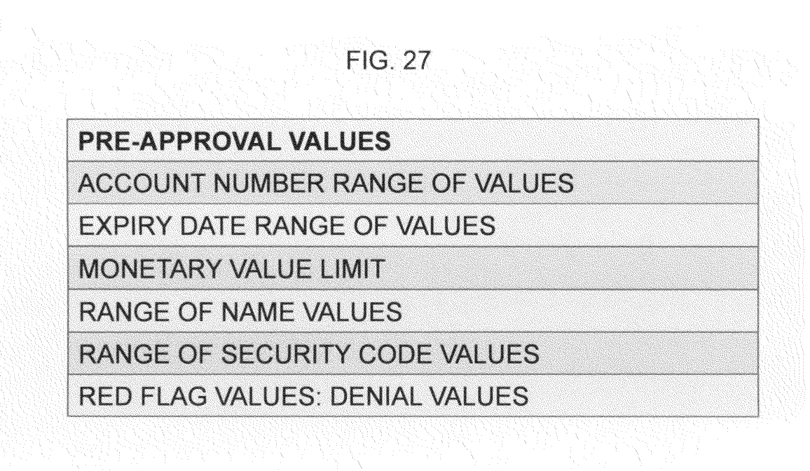

Alternately, optionally or additionally, one or more gadgets 11.A-11.N receives a credit account payment information from a user and optionally records a user issued Payment authorization record comprising the credit account payment information, as discussed herein and in particular regarding the method of FIG. 25 and the information of FIGS. 25 and 26.

Referring now generally to the Figures and particularly FIG. 21, FIG. 21 is an illustration of a gadget selection menu 58 that is displayed on the video screen 22B. The computer 2 enables the user to select one or more gadget profiles 17.A-17.D to cause the selection and enablement of gadgets 11.A-11.N as per step 20.06 of the flowchart of FIG. 20. The user may select a gadget profile 17.A-17.D for enablement or use by manipulating the computer mouse 20A to position the cursor 54 into or over the selection icon 56 most proximate to a visual representation of a title of the desired gadget profile 17.A-17.D; and (b.) then clicking the selection button 20D of the mouse 20A.

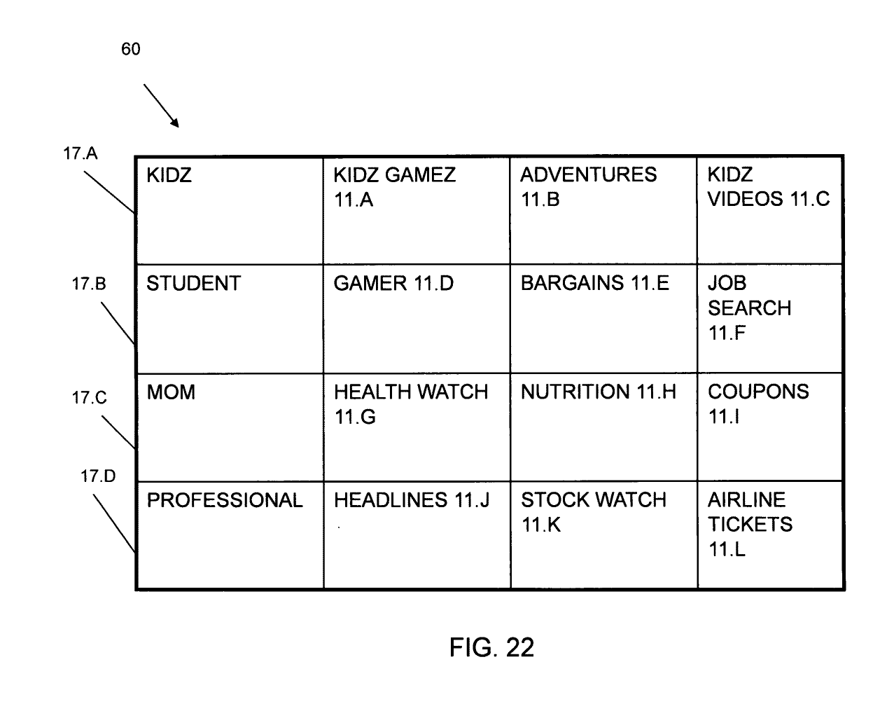

Referring now generally to the Figures and particularly FIG. 22, FIG. 22 is a schematic of a gadget profile data structure 60 that includes the gadget profiles 17.A-17.D. The gadget profile data structure may be stored within the system memory 36.

The KID gadget profile 17.A includes pointers to three gadgets, namely a KIDZ GAMEZ gadget 11.A, an ADVENTURES 11.B gadget 11.B, and a KIDZ VIDEOS gadget 11.C. A selection of the KIDZ gadget profile 17.A by the user for enablement directs the computer 2 to enable the gadgets 11.A, 11.B & 11.C referenced within the KIDZ gadget profile 17.A.

The STUDENT gadget profile 17.B includes pointers to three gadgets, namely a GAMER gadget 11.D, a BARGAINS shopping gadget 11.E, and a JOB SEARCH gadget 11.F. A selection of the STUDENT gadget profile 17.B by the user for enablement directs the computer 2 to enable the gadgets 11.D, 11.E & 11.F referenced within the STUDENT gadget profile 17.B.

The MOM gadget profile 17.C includes pointers to three gadgets, namely a HEALTH WATCH gadget 11.G, a NUTRITION gadget 11.H, and a COUPONS gadget 11.I. A selection of the MOM gadget profile 17.C by the user for enablement directs the computer 2 to enable the gadgets 11.G, 11.H & 11.I referenced within the MOM gadget profile 17.C.

The PROFESSIONAL gadget profile 17.D includes pointers to three gadgets, namely a news HEADLINES gadget 11.J, a STOCK WATCH gadget 11.K, and an AIRLINES shopping gadget 11.L. A selection of the PROFESSIONAL gadget profile 17.D by the user for enablement by the user for enablement directs the computer 2 to enable the gadgets 11.J, 11.K & 11.L referenced within the PROFESSIONAL gadget profile 17.D.

One or more gadgets 11.A-11.N listed in a gadget profile 17.A-17.D may be located partly or totally located on the server 27 or elsewhere on the network 28 and downloaded in part or in full to the computer 2 when a user selects a gadget profile 17.A-17.D for enablement and directs the computer 2 to enable the gadgets 11.A-11.N listed in or referenced by a gadget profile 17.A-17.D.

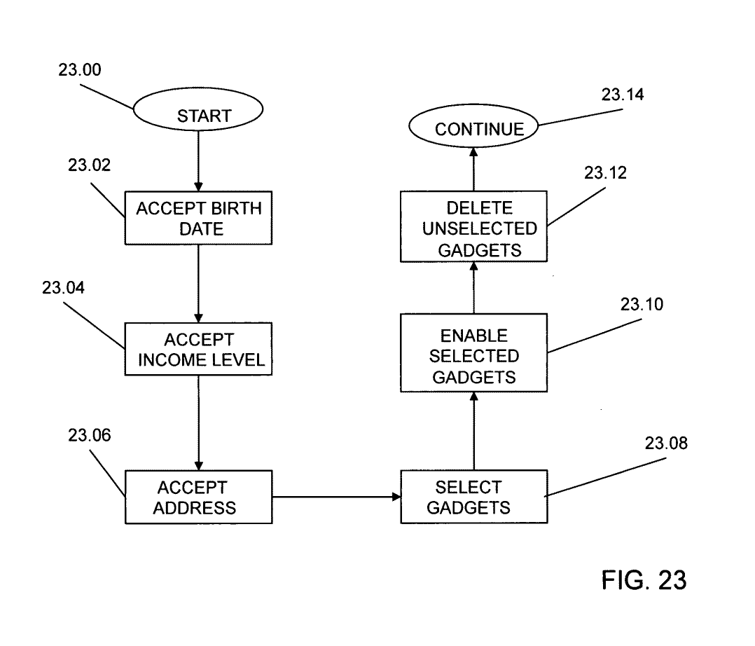

Referring now generally to the Figures and particularly FIG. 23, FIG. 23 is a flowchart of a process that may be performed by the computer 2 in communication with the network 28 whereby one or more gadgets 11.A-11.N are enabled upon the basis of information describing or supplied by a user or a third party. In step 23.o2 the computer 2 accepts a birth date of a user. In step 23.06 the computer 2 accepts an income level of a user. In step 23.06 the computer 2 accepts a postal address related to a user. In step 23.08 the computer 2 selects gadgets 11.A-11.N for enablement at least partly on the basis of the data supplied in steps 23.02, 23.04 and/or step 23.06. In step 23.10 the computer 2 enables the gadget or gadgets 11.A-11.N selected in step 23.08. In optional step 23.12 the computer 2 deletes one or all gadgets 11.A-11.N that were not selected in step 23.8 or enabled in step 23.10.

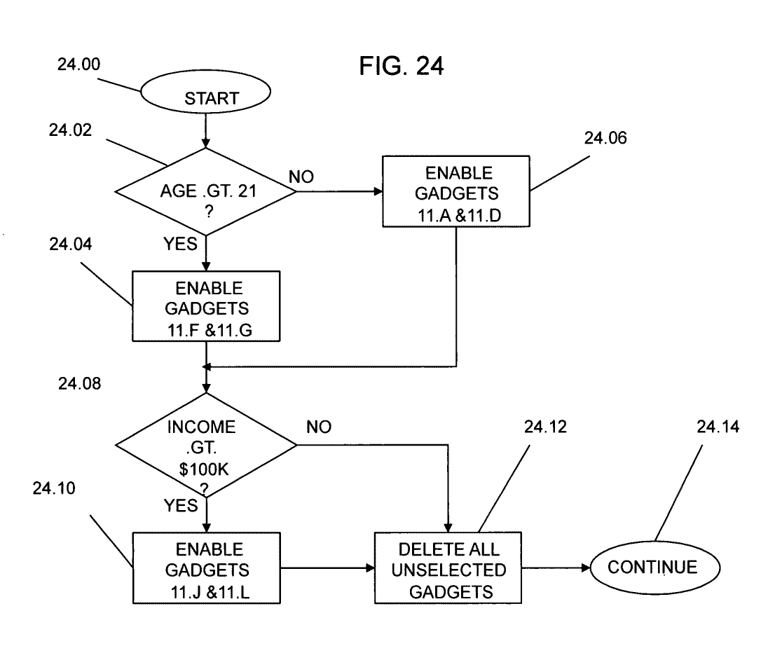

Referring now generally to the Figures and particularly FIG. 24, FIG. 234 is a flowchart of a process that may be performed by the computer 2 in communication with the network 28 whereby one or more gadgets 11.A-11.N are selected and enabled at least partly upon the basis of information describing or supplied by a user or a third party. In step 24.02 the computer 2 determines whether an age data describing the user indicates whether the user is greater than 21 years of age. When the computer 2 determines in step 24.02 that the age data describing the user indicates that the user is greater than 21 years of age, the computer 2 proceeds from step 24.02 to step 24.04 and to select and enable particular gadgets 11.F & 11.G. When the computer 2 determines in step 24.02 that the age data describing the user does not indicate that the user's age is greater than 21 years, the computer 2 proceeds from step 24.02 to step 24.06 and to select and enable particular gadgets 11.A & 11.D. The computer 2 proceeds from step 24.04 and 24.06 to step 24.08.

The computer 2 determines in step 24.08 whether an annual income data related to the user indicates whether the user's annual income is greater than US $100,000. When the computer 2 determines in step 24.08 that the annual income data related to the user indicates that the user's annual income is greater than US $100,000, the computer 2 proceeds from step 24.08 and to select and enable particular gadgets 11.J & 11.L in step 24.10. When the computer 2 determines in step 24.08 that the annual income data related to the user indicates that the user's annual income is not greater than US $100,000, the computer 2 proceeds from optional step 24.12 to delete all gadgets 11.A-11.N that were not selected or enabled in previous actions performed by the computer 2. The computer 2 may, in accordance with the method of the present invention, proceed from step 24.08, step 24.10, or step 24.12 to step 24.14 and to execute alternate computational processes.

It is understood that each and every step and process described herein relating to a software application 10.A-10.N may, in one or more various aspects of the method of the present invention, may be applied by the computer 2 and/or the network 28 to enabling, supporting or managing one or more gadgets 11.A-11.N.

Referring now generally to the Figures and particularly FIG. 25, FIG. 25 is a flowchart of a gadget enablement process that may be performed by the computer 2 in communication with the network 28 wherein the computer 2 determines whether one or more gadgets 11.A-11.N that have been selected for access by the user require a payment authorization in order to be enabled by the computer 2. In step 25.02 the computer 2 determines whether the exemplary selected first gadget 11.A requires a payment authorization for enablement. When the computer 2 determines in step 25.02 that the first exemplary selected gadget 11.A does not require a payment authorization for enablement, the computer 2 proceeds onto enable the first gadget 11.A in step 25.04. The computer 2 then proceeds from step 25.04 to step 25.06 and to step 25.06 and to execute alternate computational processes.

When the computer 2 determines in step 25.02 that the first gadget 11.A does require a payment authorization for enablement, the computer 2 proceeds onto step 25.08 to receive and record financial account information from the user. After receipt and recordation of the financial account information in step 25.08 the computer 2 proceeds to step 25.10 to generate a credit data CREDIT. DATA of FIG. 26 and then transmit the user provided financial account information via the network 28 to the server 26.

The server 26 then confirms the validity of the financial account information received from the user in step 25.08 with a financial account clearance server 38, and, if authorized by the financial account clearance server 36, the server 26 completes the operation of requesting and accepting authorization to bill the identified account for the amount due as required to enable user access to the first gadget 11.A. The communication between the server 26 and the financial account clearance server 36 is accomplished via the network 28.

When the computer 2 determines in step 25.12 that the server 26 has transmitted authority to enable the first gadget 11.A, the computer 2 proceeds on to step 25.14 to enable the gadget for user access via the computer 2. When the computer 2 does not determine a receipt of authorization authority to enable the first gadget 11.A in step 25.12, the computer 2 proceeds back to execute step 25.08.

In an alternate process step 25.08, the financial account information is processed by at least one gadget 11.B-11.N, wherein the processing gadget 11.B-11.N is enabled to authorize access to a first applications program upon receipt of a credit account payment information.

Referring now generally to the Figures and particularly to FIG. 26, the CREDIT.DATA purchase message contains information received from the user to include a computer identifier that identifies the computer 2 and optionally a network address, product model identification and a product serial number; a gadget identifier that identifies a gadget 11.A-11.N and optionally a product model identification and a product serial number of the referenced gadget 11.A-11.N; an applications software identifier that identifies an applications software 10.A-10.N and optionally a product model identification and a product serial number of the referenced applications software 10.A-10.N; a name of a financial credit account holder; an account number of the same financial credit account; a billing address of the same financial credit account; a security code of the same financial credit account; a monetary value requested by the user to charge to the same financial credit account; an expiry date of the same financial credit account; and optionally an electronic signature by the user that indicates authorization of the monetary value the referenced financial credit account.

Upon receipt of authorization from server 26 by the computer 2 to enable access to one or more gadgets 11.A-11.N and/or applications software 10.A-10.N, the computer 2 may add server authorization information to the CREDIT.DATA purchase message and then store CREDIT.DATA purchase message as a record of payment for user access to the one or more gadgets 11.A-11.N and/or applications software 10.A-10.N referenced by the CREDIT.DATA purchase message and/or the server authorization information.

Referring now generally to the Figures and particularly to FIG. 27, the computer 2 will, under certain other additional aspects of the method of the present invention, authorize use of one or more gadgets 11.A-11.N and/or applications software 10.A-10.N even when the computer 2 has not received authorization from server 26, the financial account clearance server 36 or via the network 28. In these instances, the computer 2 generates a CREDIT.DATA purchase message and provisionally or temporarily enables one or more gadgets 11.A-11.N and/or applications software 10.A-10.N referenced in the CREDIT.DATA purchase message. Optionally, the computer 2 may, in the process of authorizing a gadget 11.A-11.N or application software 10.A-10.N, compare one or more values of the instant CREDIT.DATA purchase message to insure that the compared values do not exceed preset ranges. In particular, the PRE-APPROVAL VALUES data may include ranges for financial account numbers, expiry dates, monetary amounts required for full access authorization of the method of FIG. 25; ranges of alphanumeric values for the name of the account holder; and ranges of values for credit account security codes. The PRE-APPROVAL VALUES data may also include values of one or more information type that, when present in the CREDIT.DATA purchase message will direct the computer 2 to not enable user access to one or more gadgets 11.A-11.N and/or applications software 10.A-10.N referenced in the CREDIT.DATA purchase message.

The foregoing disclosures and statements are illustrative only of the present invention, and are not intended to limit or define the scope of the present invention. The above description is intended to be illustrative, and not restrictive. Although the examples given include many specificities, they are intended as illustrative of only certain possible applications of the present invention. The examples given should only be interpreted as illustrations of some of the applications of the present invention, and the full scope of the Present Invention should be determined by the appended claims and their legal equivalents. Those skilled in the art will appreciate that various adaptations and modifications of the just-described applications can be configured without departing from the scope and spirit of the present invention. Therefore, it is to be understood that the present invention may be practiced other than as specifically described herein. The scope of the present invention as disclosed and claimed should, therefore, be determined with reference to the knowledge of one skilled in the art and in light of the disclosures presented above.

What is claimed is:

1. In a computer comprising a plurality of applications programs, a method of personalizing a software configuration of the computer, the method comprising:
a. at least two user profiles, each profile referencing at least one gadget;
b. receiving from a user a selection of a user profile chosen from the at least two profiles; and
c. enabling access to each gadget referenced by the user selected user profile to a user by means of the computer.

2. The method of claim 1, wherein at least one gadget provides a functionality to the user selected from the functionality group essentially consisting of email communications, contact data recordation and access, information security, world wide web browsing, word processing, spreadsheet computation, software database access, software database management, graphics generation, video data rendering, a video data editing, an audio data editing, and a calendar data access and recordation.

3. The method of claim 1, wherein at least one gadget is enabled by a plurality of machine-readable software instruction stored at least partially on a disc memory of the computer.

4. The method of claim 1, wherein the computer is bi-directionally communicatively coupled with a server and at least gadget is at least partially download from the server.

5. The method of claim 1, wherein the computer is bi-directionally communicatively coupled with a server and at least one gadget is configured to execute a download of software encoded instructions from the server.

6. The method of claim 5, wherein the server and the computer are bi-directionally communicatively coupled via the Internet.

7. The method of claim 5, wherein the server and the computer are bi-directionally communicatively coupled via a wireless communications network.

8. The method of claim 7, wherein the computer is selected from the device group consisting of a cellular telephone, a wireless communications enabled personal digital assistant, and a wireless communications enabled personal computer.

9. The method of claim 1, further comprising:
d. the at least one gadget of the selected user profile offering a plurality of communications applications to the user;
e. the user selecting at least one communications programs from the plurality of communications applications; and
f. the computer enabling the execution of the user selected at least one communications program.

10. The method of claim 9, wherein the plurality of communications programs include a messaging utility selected from the utility software group consisting of an email client, a web-enabled email client, an instant messaging client, a text messaging client, and a short messaging telephony client.

11. The method of claim 1,
d. the at least one gadget of the selected user profile offering a plurality of information security software applications to the user;
e. the user selecting at least one information security software application from the plurality of information security software applications; and
f. the computer enabling the execution of the user selected at least one information security software application.

12. The method of claim 1, further comprising:
d. presenting at least two of warranty agreements to the user;
e. receipt by the computer of a selection by the user of at least one warranty agreement; and
f. recordation by the computer of the selection by the user of at least one warranty agreement

13. The method of claim 1, wherein at least one gadget receives a credit account payment information from a user and records a user issued payment authorization record comprising the credit account payment information.

14. A method of personalizing a gadget configuration of a computer, the method comprising:
a. associating at least two profiles within the computer, each profile indicating a at least one gadget;
b. presenting the at least two profiles to a user via the computer;
c. receiving from a user a selection of a user profile of the at least two profiles; and
d. enabling access via the computer to each gadget referenced by the user selected user profile.

15. The method of claim 14, wherein at least one gadget enables access to an applications program is selected from the software group consisting of an email client, an address book, a computer security program, a web browser, a word processing program, a financial spreadsheet program, a software database, a software database management system, a graphics generation program, a video player, a video data editor, an audio data editor, and a calendar software.

16. The method of claim 15, wherein at least one applications program is at least partially stored on a disc memory of the computer.

17. The method of claim 15, further comprising:
e. bi-directionally communicatively coupling the computer with a server; and
f. downloading at least part of the at least one applications program from the server.

18. The method of claim 17, wherein the computer and the server are bi-directionally communicatively coupled to an electronics communications network selected from the network group consisting of the Internet, an intranet, an extranet, an electronic computer network, a telephony system, a wireless telephony system, and a wireless electronics communications network.

19. The method of claim 14, wherein at least one gadget is enabled to authorize access to a first applications program upon receipt of a credit account payment information.

20. A computer comprising:
a memory, the memory storing a plurality of gadgets;
a central processing unit (“CPU”), the CPU bi-directionally communicatively coupled with the memory and the CPU configured to execute each of the plurality of gadgets;
a directory of gadgets, the directory including at least two profiles, each profile indicating a unique listing of gadgets;
means to receive a user a selection of a user profile chosen from the at least two profiles; and
means to enable access to the user to each gadget listed in each profile selected by the user.
